(19) United States
(12) Patent Application Publication
(10) Pub. No.: US 2025/0007584 A1
(43) Pub. Date: Jan. 2, 2025

(54) CSI AND SRS UPDATE UPON TCI ACTIVATION

(71) Applicant: InterDigital Patent Holdings, Inc., Wilmington, DE (US)

(72) Inventors: Patrick Svedman, Stockholm (SE); Pascal Adjakple, Great Neck, NY (US); Kyle Pan, Saint James, NY (US); Allan Tsai, Boonton, NJ (US)

(73) Assignee: InterDigital Patent Holdings, Inc., Wilmington, DE (US)

(21) Appl. No.: 18/708,361

(22) PCT Filed: Nov. 8, 2022
(86) PCT No.: PCT/US2022/079465

§ 371 Date: May 8, 2024

Related U.S. Application Data
(60) Provisional application No. 63/276,762, filed on Nov. 8, 2021.

(51) Int. Cl. H04B 7/06

(52) U.S. Cl. CPC H04B 7/0626; H04B 7/06968

(57) ABSTRACT

Methods, apparatus, and systems are described for improved channel state information (CSI) and sounding reference signal (SRS) update upon transmission configuration indicator (TCI) activation in 5G networks.

### CROSS-REFERENCE TO RELATED APPLICATIONS

This application claims the benefit of U.S. Provisional Patent Application No. 63/276,762, filed Nov. 8, 2021, and entitled “CSI AND SRS UPDATE UPON TCI ACTIVATION,” the content of which is incorporated by reference herein in its entirety.

### BACKGROUND

The 3rd Generation Partnership Project (3GPP) develops technical standards for cellular telecommunications network technologies, including radio access, the core transport network, and service capabilities—including work on codecs, security, and quality of service. Recent radio access technology (RAT) standards include WCDMA (commonly referred as 3G), LTE (commonly referred as 4G), and LTE-Advanced standards. 3GPP has begun working on the standardization of next generation cellular technology, called New Radio (NR), which is also referred to as “5G.”

A base station (BS) may configure a user equipment (UE) with a large set of Transmission Configuration Indicator (TCI) states, activate a subset of TCI states (e.g., 8) by Medium Access Control (MAC) Control Element (CE), and indicate a small set (e.g., one) of TCI states for downlink (DL)/uplink (UL) control and data channels by Downlink Control Information (DCI). The beams/Transmission and/or Reception Points (TRPs) used to transmit the DL Reference Signal(s) (RS) associated with the activated TCI states may be seen as a set of candidate beams/TRPs for control/data channels. Hence, Channel State Information (CSI) reporting based on the activated TCI states may be desired. Moreover, Sounding RS (SRS) transmission based on the activated TCI states may be desired. However, the CSI reporting and SRS configuration are separately configured from the TCI state activation and frequent reconfiguration (e.g., associated with overhead and latency) may be required to enable CSI reporting of and/or SRS transmission based on the activated TCI states.

Channel State Information (CSI) and Sounding Reference Signal (SRS) update upon Transmission Configuration Indicator (TCI) activation in 5G networks may encompass a wide variety of scenarios, servers, gateways, and devices, such as those described in, for example, 3GPP NR Release 15/16 and 3GPP NR Release 17.

### SUMMARY

Described herein are methods, apparatus, and systems for improved CSI and SRS update upon TCI activation. One or more methods to update CSI measurement and reporting upon activation/deactivation of TCIs are described. One or more methods to update SRS upon activation/deactivation of TCIs are described.

According to some aspects, a Radio Resource Control (RRC) configuration may be received. CSI measurement and reporting may be updated upon activation/deactivation of TCIs. For example, the RRC configuration may include a set of Transmission Configuration Indicator (TCI) states and an indication to base a Channel State Information (CSI) resource set on a subset of the set of TCI states may be received (e.g., from a network). According to some aspects, SRS may be updated upon activation/deactivation of TCIs. For example, the RRC configuration may include a set of TCI states, a CSI resource set, and an indication to base a TCI state of a CSI resource in the CSI resource set on an activated subset of the set of TCI states.

According to some aspects, a medium access control (MAC) control element (CE) may be received and the subset of the set of TCI states may be activated based on the MAC CE and for Physical Downlink Shared Channel (PDSCH) reception. According to some aspects, the CSI resource set may be determined based on the activation of the subset of TCI states. For example, the one or more linked CSI resources may be added to the CSI resource set and/or the subset of the set of TCI states may include one or more source reference signals. CSI measurement and CSI reporting may be performed based on the CSI resource set. According to some aspects, the subset of the set of TCI states may include one or more source reference signals. Determining the CSI resource set may include adding the one or more source reference signals to the CSI resource set.

According to some aspects, a TCI state in the subset of the set of TCI states may be determined (e.g., based on the activation of the subset of TCI states) as a TCI state for a CSI resource in the CSI resource set. According to some aspects, determining the CSI resource set may include adding the one or more source reference signals to the CSI resource set.

According to some aspects, a reference signal may be determined based on a TCI state identifier associated with the subset of TCI states. Moreover, a TCI state of the subset of TCI states may include a configuration of a link between the TCI state and a reference signal.

According to some aspects, an aperiodic channel state information reference signal (CSI-RS) resource may be configured to use a TCI state of the subset of TCI states. A downlink control information (DCI) may comprise a TCI field (e.g., comprising 3 bits and representing 8 codepoints, such as 0, 1, 2, . . . , 7) and the activated TCI states may correspond to different codepoints of the TCI field. A TCI state of the subset of TCI states may be mapped to a lowest codepoint of a TCI field in a DCI (e.g., relative to the other TCI states of the subset of TCI states) and the TCI state may be mapped to a first CSI-RS resource of the CSI resource set. A use of a TCI state of the subset of TCI states may be configured per a CSI-RS resource set. A bandwidth part (BWP) or serving cell may include a plurality of activated sets (e.g., subsets) of TCI states comprising the subset of TCI states. Each of the plurality of activated sets (e.g., subsets) may be one-to-one mapped to a control resource set (CORESET) pool.

According to some aspects, CSI measurement and CSI reporting may be performed based on the CSI resource set. According to some aspects, a CSI report may be associated with a CORESET pool. Moreover, the CSI report may be based on a CSI reporting setting.

According to some aspects, for periodic CSI, the set of RSs (e.g., CSI-RS and/or SSB) that is used for measurement and report for a CSI report may be based on the set of activated TCIs. Either RSs directly in the activated TCIs or RSs that are associated with the activated TCIs may be included in the set of RSs used for the measurement and reporting. According to some aspects, aspects may save reconfiguration overhead and latency, e.g., since the network may receive timely CSI reports based on the set of activated TCIs. For aperiodic CSI, the TCIs of triggered CSI-RS may be taken from the set of activated TCIs. Without reconfiguration overhead and latency, a single aperiodic CSI report may provide CSI corresponding to the currently activated TCIs.

According to some aspects, for an SRS resource set (e.g., periodic, semi-persistent or aperiodic), the spatial reference(s) for the included SRS resources may be based on the set of activated TCIs. Without having to reconfigure a SRS resource set or provide MAC CE based spatial relation updates, a transmission occasion of an SRS resource set by the UE and the measurement by the network may give timely UL CSI to the network corresponding to the set of activated TCIs.

According to some aspects, activated TCI states may be candidate TCI states for PDCCH/PDSCH/PUCCH/PUSCH.

According to some aspects, CSI reporting may be automatically updated upon TCI state activation, e.g., so that the network may get a CSI report corresponding to the activated TCI states without having to reconfigure the CSI reporting or reference signals.

For periodic CSI, the set of RSs (e.g., CSI-RS and/or SSB) that is used for measurement and report for a CSI report may be based on the set of activated TCIs. Either RSs directly in the activated TCIs or RSs that are associated with the activated TCIs are included in the set of RSs used for the measurement and reporting. This may save reconfiguration overhead and latency, since the network may receive timely CSI reports based on the set of activated TCIs. For aperiodic CSI, the TCIs of triggered CSI-RS may be taken from the set of activated TCIs. Without reconfiguration overhead and latency, a single aperiodic CSI report may provide CSI corresponding to the currently activated TCIs.

According to some aspects, SRS transmission and the spatial reference signals used for the transmission may be automatically updated upon TCI state activation, e.g., so that the network can perform SRS based channel measurement corresponding to the activated TCI states without reconfiguring or updating the SRS or corresponding spatial reference signals.

For an SRS resource set, which may be periodic, semi-persistent or aperiodic, the spatial reference(s) for the included SRS resources may be based on the set of activated TCIs. Without having to reconfigure a SRS resource set or provide MAC CE based spatial relation updates, a transmission occasion of an SRS resource set by the UE and the measurement by the network may give timely UL CSI to the network corresponding to the set of activated TCIs.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

A more detailed understanding may be had from the following description, given by way of example in conjunction with the accompanying drawings.

FIG. 1 shows an example UE procedure for updating CSI based on TCI activation;

FIG. 2 shows an example of inclusion of linked RS;

FIG. 3 shows an example of triggered AP CSI-RS resources and corresponding TCIs at two time instants;

FIG. 4 shows example CSI-RS resources in an AP CSI-RS resource set;

FIG. 5 shows example CSI-RS resources in an AP CSI-RS resource set;

FIG. 6 shows example CSI-RS resources in an AP CSI-RS resource set;

FIG. 7 shows an example UE procedure;

FIG. 8 shows an example process to determine transmitted SRS resources and corresponding spatial references from activated TCIs and an SRS resource set at two different times;

FIG. 9 shows example SRS resources in an SRS resource set;

FIG. 10 shows example SRS resources in an SRS resource set;

FIG. 11 shows example SRS resources in an SRS resource set;

FIG. 12A shows an example communications system;

FIGS. 12B, 12C, and 12D show system diagrams of example RANs and core networks;

FIG. 12E shows another example communications system;

FIG. 12F shows a block diagram of an example apparatus or device, such as a WTRU; and

FIG. 12G shows a block diagram of an exemplary computing system.

### DETAILED DESCRIPTION

Table 0.1 describes some of the abbreviations used herein.

TABLE 0.1
Abbreviations

| | |
|---|---|
| ACK | Acknowledgement |
| AP-CSI | Aperiodic CSI |
| AP-SRS | Aperiodic SRS |
| BM | Beam Management |
| CC | Component Carrier |
| CORESET | Control Resource Set |
| CSI | Channel State Information |
| CSI-RS | Channel State Information RS |
| DCI | Downlink Control Information |
| DL | Downlink |
| DMRS | Demodulation RS |
| DTX | Discontinuous Transmission |
| FR | Frequency Range |
| FR1 | FR spanning lower frequencies, e.g., |
| | 410 MHz-7125 MHz |
| FR2 | FR spanning higher frequencies, e.g., |
| | 24250 MHz-52600 MHz |
| gNB | NR NodeB |
| ID | identity and/or index |
| IE | Information Element |
| FeMIMO | Further enhanced MIMO (a 3GPP Rel-17 work item) |
| L1 | Layer 1 |
| MAC | Medium Access Control |
| MAC CE | MAC Control Element |
| MIMO | Multiple Input Multiple Output |
| ms | milliseconds |
| NACK | Negative ACK |
| NR | New Radio |
| NW | Network |
| NZP | Non-Zero Power |
| PCell | Primary Cell |
| P-CSI | Periodic CSI |
| P-SRS | Periodic SRS |
| PDCCH | Physical Downlink Control Channel(s) |
| PDSCH | Physical Downlink Shared Channel(s) |
| PHY | Physical Layer |
| PUCCH | Physical Uplink Control Channel(s) |
| PUSCH | Physical Uplink Shared Channel(s) |
| QCL | Quasi Co-Location |
| RAN | Radio Access Network |
| Rel | Release |
| RRC | Radio Resource Control |
| RS | Reference Signal(s) |
| RSRP | RS Received Power |
| RX (or Rx) | Reception or Receive or Receiver |
| SCell | Secondary Cell |
| SFN | Single Frequency Network |
| SNR | Signal to Noise Power Ratio |
| SINR | Signal to Interference and Noise Power Ratio |
| SpCell | Special Cell (PCell or PSCell) |
| SP-CSI | Semi-persistent CSI |
| SP-SRS | Semi-persistent SRS |
| SRS | Sounding RS |
| SS | Synchronization Signal |
| SSB | SS/PBCH Block |
| SSS | Search Space Set |
| TB | Transport Block |
| TCI | Transmission Configuration Indicator |
| TRP | Transmission and/or Reception Point |
| TRS | Tracking Reference Signal(s) (or CSI-RS (resource |
| | set) for tracking) |
| TX (or Tx) | Transmission or Transmit or Transmitter |
| UE | User Equipment |
| UL | Uplink |
| ZP | Zero power |

In one aspect, a network may configure/indicate QCL-relationships between different RSs to a UE. A QCL-relationship may have a source RS and a target RS. The target may also be a physical channel. The QCL-relationship may assist the UE in the reception and/or processing of the target RS by applying one or more parameters estimated from the source RS.

The network may configure one or more kinds of parameters a QCL-relationship may hold. For example, the following QCL types may be defined:
‘QCL-TypeA’: (Doppler shift, Doppler spread, average delay, delay spread)
‘QCL-TypeB’: (Doppler shift, Doppler spread)
‘QCL-TypeC’: (Doppler shift, average delay)
‘QCL-TypeD’: {Spatial Rx parameter}

The source RS may be a Synchronization signal/PBCH block (SSB) or a CSI-RS resource (e.g., CSI-RS). The target RS may be a CSI-RS resource, a DMRS of PDCCH, or a DMRS of PDSCH.

TCI may be used by the network to indicate a certain relationship between different signals and/or channels, e.g., quasi co-location (QCL), as described regarding QCL in NR. Some properties (e.g., parameters) may be derived from a source RS in a TCI and may be used while receiving and/or decoding a target RS or channel. One example of such a property is a spatial Rx parameter (e.g., QCL-TypeD). Such a QCL relation may imply that the UE may derive a suitable receive beam for the target RS/channel from the source RS. Other examples may include parameters related to Doppler and delay. In some cases, the UE may derive properties from the target RS and may apply the derived properties to the reception of the source RS.

According to some aspects, a beam may refer to a TCI and a TCI may correspond to a beam. Moreover, a beam may correspond to a DL TX beam and/or a DL RX beam, since different DL TX beams may require different DL RX beams. A beam may also correspond to a UL TX beam, since different DL TX beams may correspond to different UL TX beams, e.g., in the case DL RSs are used as spatial references for UL TX beams. However, examples herein that use the beam terminology may also be applicable to cases in which TCIs do not contain QCL for a spatial parameter, such as for carrier frequencies in FR1. For instance, examples using the terminology “common beam operation” may also be applicable to cases in which spatial parameters are not applicable, e.g., TCIs do not include source RS with QCL-TypeD. For example, in lower frequency bands such as FR1, a UE may be configured with TCI states with, for instance, only QCL-TypeA or QCL-TypeC, since a UE might not need to perform DL RX beam training prior to DL signal/channel reception, or UL TX beam training prior to UL signal/channel transmission.

The term TCI state may be used herein as a configuration element or information element (e.g., TCI-State or TCI-State-r17), e.g., including one or more RS, corresponding QCL type(s), etc. As further discussed below, one or more TCI may be determined or derived from a TCI state. For example, a DL TCI and a UL TCI may be determined from a TCI state. The term TCI codepoint may be used herein as an allowed value of a TCI field in a DCI. A TCI codepoint may map to one or more TCI states, e.g., multiple DL TCI states or one TCI state used for DL TCI and one TCI state used for UL TCI. A TCI codepoint may map to one or more TCIs, e.g., one DL TCI and one UL TCI. Note that a TCI state may correspond to one or more TCIs. A TCI state may be mapped to no TCI codepoint, one TCI codepoint or multiple TCI codepoints.

The term DL-only TCI may be used to indicate that a TCI codepoint is mapped to a DL TCI, but not to a UL TCI. Similarly, the term UL-only TCI may be used to indicate that a TCI codepoint is mapped to a UL TCI, but not to a DL TCI.

According to some aspects, NR in Rel-15/16 may support a flexible framework for configuring/indicating QCL information for various signals and channels. For the downlink (DL), different QCL information may be applied to different CSI-RS, different CORESETs (e.g., used for monitoring and receiving PDCCH) and PDSCH. Moreover, different QCL information may be applied to different bandwidth parts (BWPs) in a cell and to different cells. This may imply a large signaling overhead, even if all the signals and channels use the same beam pair (e.g., the beam at the transmitter and the beam at the receiver), which is a quite common scenario. As a consequence, common beam operation was introduced in NR Rel-17, e.g., for overhead and latency reduction. Common beam operation is directly related to and sometimes synonymous with a unified TCI framework.

For the uplink (UL) in NR Rel-15/16, the network may use spatial relations to inform the UE which spatial domain transmission filter to use for a signal/channel. If the spatial relation for a UL signal/channel comprises a DL RS, the UE may use, as spatial domain filter for transmitting (e.g., UL TX spatial filter) the UL signal/channel, the spatial domain filter used for receiving the DL RS. If the spatial relation for a UL signal/channel comprises a UL RS, the UE may use, as spatial domain filter for transmitting the UL signal/channel, the spatial domain filter used for transmitting the UL RS (in the spatial relation). A spatial domain filter may correspond to a beam used for transmission or reception at the UE. To simplify operation, e.g., when the same DL RS is used as DL QCL source and as UL spatial relation source, UL spatial reference is also incorporated into the unified TCI framework.

In common beam operation, source reference signal(s) in M (e.g., M=1 or M>1) DL TCI(s) provide common QCL information, e.g., for UE-dedicated reception on PDSCH and one or more subset(s) of CORESETs (e.g., all configured CORESET(s)) in a CC (e.g., a serving cell). The common QCL information may also be applied to CSI-RS resources for CSI (e.g., for aperiodic CSI-RS (AP-CSI-RS) for CSI measurement and reporting), CSI-RS for tracking, and/or CSI-RS for beam management (e.g., AP-CSI-RS configured with repetition). For the example of M=2, the UE simultaneously maintains two DL TCIs, where the two DL TCIs may be used for transmissions from two TRPs, respectively. Which TCI to use (e.g., for PDCCH monitoring, subsequent PDSCH, PUSCH, PUCCH, etc.) may depend on the CORESET pool with which the transmission is associated.

Source reference signal(s) in N (e.g., N=1 or N>1) UL TCI(s) provide common QCL information (or reference) for determining UL TX spatial filter, e.g., for dynamic-grant/configured-grant based PUSCH and all of the dedicated PUCCH resources in a CC (e.g., a serving cell). The common QCL information may also be applied to SRS resources in resource set(s) configured for antenna switching/codebook-based/non-codebook-based UL transmissions. It may also be applied to some aperiodic SRS for beam management.

The M and/or N TCI(s) may be applied to one or more serving cells, e.g., all cells in a band or all cells in a configured list of serving cells. The TCI(s) may be applied to one, a subset, or all DL and/or UL BWPs of those serving cell(s).

A joint TCI may refer to a common source RS used for determining both a DL QCL information (e.g., QCL-TypeD) and the UL TX spatial filter. In this case, M may be equal to N. Separate TCI may refer to the case that the DL TCI and the UL TCI are distinct, e.g., separate. In this case, M may be equal to N or different from N. In some aspects, a DL TCI may correspond to a DL TCI part of a separate TCI or to a DL TCI part of a joint TCI. Similarly, a UL TCI may correspond to a UL TCI part of a separate TCI or to a UL TCI part of a joint TCI.

In some cases, a pool of TCI states may be RRC configured to the UE, where a TCI state may be used to derive joint TCI, (separate) DL TCI and/or (separate) UL TCI. For example, a TCI state may comprise a set of source RSs with corresponding (per-RS) QCL type information.

In a case of joint TCI, both DL TCI and UL TCI may be derived from a same TCI state. For example, a source RS with QCL-TypeD in a TCI state may be used for spatial QCL in the DL TCI as well as the spatial relation (or QCL) in the UL TCI. In other words, the UE may use the same source RS to determine a DL RX beam as well as to determine a UL TX beam.

In case of separate TCI, DL TCI may be derived from a TCI state in the pool and UL TCI may be derived from another TCI state in the same pool.

In some cases, multiple pools of TCI states may be RRC configured to the UE, where the pools may be disjoint or overlapping. For example, a first pool of TCI states may be used to derive joint TCI or DL TCI (e.g., separate), while a second pool of TCI states may be used to derive UL TCI (e.g., separate). In one example, the content of TCI states in the second pool may be similar to the content of the TCI states in the first pool, e.g., include the same set of mandatory and optional parameters. In another example, the content of TCI states in the second pool may be different from the content of the TCI states in the first pool, e.g., include a smaller set of UL-related mandatory and optional parameters. For example, a TCI state could comprise a set of source RSs with corresponding (e.g., per-RS) QCL type information.

In a case of joint TCI, both DL TCI and UL TCI may be derived from a same TCI state from the first pool of TCI states. For example, a source RS with QCL-TypeD in a TCI state is used for spatial QCL in the DL TCI as well as the spatial relation (or QCL) in the UL TCI. In other words, the UE may use the same source RS to determine a DL RX beam as well as to determine a UL TX beam.

In a case of separate TCI, a DL TCI may be derived from a TCI state in the first pool and a UL TCI may be derived from a TCI state in the second pool. It is, however, also possible that a source RS in such a DL TCI (e.g., for QCL type D) is the same as the RS in the UL TCI, even though they correspond to different TCI states and/or even different TCI pools.

In some cases, TCI may be equivalent to TCI state, e.g., if the TCI(s) corresponding to a TCI codepoint (e.g., joint DL/UL TCI, separate DL/UL TCI, DL-only TCI, UL-only TCI) corresponds to a single configured TCI state.

A set of TCIs may be activated, using one or more MAC CEs. Purposes of activation may include:
(1) A UE tracks source RS in activated TCIs so that they may be readily used as QCIUspatial reference for other signals/channels with low delay. The UE might not be required to track source RS in TCIs that are not activated, at least to the same degree as for the source RS in TCIs that are activated; and/or
(2) Activated TCIs may be mapped to TCI codepoints. A DCI may indicate one or more TCI codepoint(s) in order to update TCI(s) for common beam operation.

In some cases, a MAC CE activates either joint TCI or separate DL/UL, e.g., all the TCIs activated in the MAC CE are either joint TCI or separate DL/UL TCI. Whether joint TCI or separate DL/UL, TCI activated by a MAC CE may for instance be RRC configured.

In some cases, a MAC CE may activate some TCIs that are joint and other TCIs that are separate DL/UL TCIs.

The M and/or N TCIs for common beam operation may be indicated, activated/deactivated, or updated dynamically using one or more DCI(s) and/or one or more MAC CE(s). According to some aspects, the term indication is often used for DCI-based signaling. For the MAC CE based signaling, the terms activation and deactivation are often used. Updating may be done after an initial indication or activation. According to some aspects, the term activation may also include the notion of deactivation, e.g., “activation or deactivation.” For example, a MAC CE that activates a first set of TCIs may implicitly deactivate a second set of TCIs that were previously activated but are not included in the first set of TCIs. In some cases, a subset of the M and/or N TCIs may be indicated/activated/updated using a DCI and/or a MAC CE. For example, a TCI indication/activation/update in a DCI and/or a MAC CE may apply to a subset of CORESETs associated with a certain CORESET pool index value (e.g., 0 or 1), e.g., through parameter coresetPoolIndex-r16.

In one example, a TCI codepoint received in a first DCI on a CORESET associated with a first CORESET pool index value may be used to indicate/activate/update the TCI(s) of CORESET(s) with the first CORESET pool index value. A TCI codepoint received in a second DCI on a CORESET associated with a second CORESET pool index value may be used to indicate/activate/update the TCI(s) of CORESET(s) with the second CORESET pool index value. For instance, if the TCI codepoint received in the first DCI indicates a first TCI and the TCI codepoint received in the second DCI indicates a second TCI, then M and/or N may be equal to 2. Furthermore, the TCI(s) applicable to PDSCH, PUSCH and/or PUCCH transmission(s) following a grant in a DCI received on a CORESET with a CORESET pool index may be the TCI(s) used for that CORESET pool index.

In another example, a TCI codepoint received in a DCI may correspond to multiple (e.g., 2) TCIs. In some cases, different subsets of these multiple TCIs are applied to different subsets of CORESET, e.g., a first TCI is applied to CORESET(s) associated with a first CORESET pool index and a second TCI is applied to CORESET(s) associated with a second CORESET pool index.

In another example, a TCI activation/update received in a first MAC CE in a PDSCH scheduled by a PDCCH received on a CORESET associated with a first CORESET pool index value may be used to indicate/activate/update the TCI(s) of CORESET(s) with the first CORESET pool index value. A TCI activation/update received in a second MAC CE in a PDSCH scheduled by a PDCCH received on a CORESET associated with a second CORESET pool index value may be used to indicate/activate/update the TCI(s) of CORESET(s) with the second CORESET pool index value.

In another example, a TCI activation/update for a codepoint received in a MAC CE may correspond to multiple, e.g., 2, TCIs. In some cases, different subsets of these multiple TCIs are applied to different subsets of CORESET, e.g., a first TCI is applied to CORESET(s) associated with a first CORESET pool index and a second TCI is applied to CORESET(s) associated with a second CORESET pool index.

In some cases, multiple TCIs (e.g., two TCIs) indicated/activated/updated by a DCI and/or MAC CE are applied to the same CORESET, e.g., a CORESET may have multiple simultaneously active TCIs.

For a joint TCI, the same TCI state may be used to determine a DL TCI and a UL TCI. For example, the UE may use the same beam for DL and for UL if the QCL-TypeD source RS for DL is also used as spatial relation/QCL for UL. For joint TCI, the MAC CE activation of a TCI state would activate both the DL TCI and the UL TCI, where the TCI state would be taken from the joint pool of TCI states or from the pool of TCI states used for joint TCI and DL TCI in the case of separate DL/UL TCI. The DL TCI and UL TCI may be mapped to the same TCI codepoint.

In the case of separate DL/UL TCI, a TCI codepoint may for example be mapped to one of the following: a DL TCI; a UL TCI; and/or a DL TCI and a UL TCI. It is possible that a MAC CE activates a DL TCI and a UL TCI for a codepoint such that they correspond to the same source RS, which may in practice be the same or similar to a joint TCI.

CSI reporting (e.g., Rel-15/16 CSI framework) may comprise many different quantities in various combinations, for example, CSI-RS Resource Indicator (CRI), Rank Indicator (RI), Precoding Matrix Indicator (PMI), Channel Quality Indicator (CQI); CRI, RI, Layer Indicator (LI), PMI, CQI; CRI, RI; CRI, RI, CQI; and L1-RSRP. Measurements may typically be based on CSI-RS, but may also be based on SSBs, e.g., for L1-RSRP.

A UE may be configured with one or more CSI reporting settings (e.g., CSI-ReportConfig) for a serving cell (e.g., in the IE CSI-MeasConfig). Each CSI reporting setting may be associated with a single DL BWP or multiple DL BWPs of the serving cell. For periodic CSI, a CSI reporting setting may be configured with type (e.g., reportConfigType) set to periodic.

A CSI reporting setting may be configured with one or more of a resource setting for channel measurement, a resource setting based on zero-power (ZP) resources for interference and noise measurement, and/or a resource setting based on non-zero-power (NZP) resources for interference measurement.

The resource setting for channel measurement may always be configured in a CSI reporting setting. The CSI reporting setting may be configured with resource setting ID(s) (e.g., CSI-ResourceConfigId) rather than resource setting(s), since the resource settings are separately configured (e.g., in the CSI measurement configuration) and configured with unique IDs.

A CSI resource setting may include a list of resource set IDs, which may correspond to NZP CSI-RS resource set and/or SSB resource sets. For periodic and semi-persistent reporting, the list may comprise a single resource set ID, except for channel measurement for L1-RSRP in which case an NZP CSI-RS resource set ID and an SSB resource set ID may be included. For aperiodic reporting, the list may comprise multiple resource set IDs, e.g., IDs for multiple NZP CSI-RS resource sets.

A CSI resource setting may also include a DL BWP ID (e.g., bwp-Id) and the resource type (e.g., resourceType) such as aperiodic, semi-persistent, or periodic.

According to some aspects, fast DL TCI switching using DCI, e.g., selection of a TCI codepoint, may be possible only between a subset of the configured DL TCIs. For example, only a DL TCI among the activated DL TCIs may be selected, where the DL TCIs may have been activated by one or more MAC CEs.

In general, it may be beneficial if the network switched the DL TCI such that the used DL TCI would always correspond to the best DL TCI, e.g., in terms of radio link reliability, radio link throughput, system performance, etc. To facilitate such switching, the network needs DL CSI corresponding to the different DL TCIs.

Firstly, the network may need to make sure that a suitable set of DL TCI are activated. This may be achieved by UE measurement and reporting of CSI based on a larger set of signals, for example all SSBs of the serving cell. For example, the UE may report the n best L1-RSRP of the SSB, where n may be 1, 2 or 4, for example. The network may then activate DL TCIs based on such “first-stage” CSI reports.

Secondly, the network may need to make sure that a sufficiently good DL TCI among the activated DL TCIs is actually used for PDCCH/PDSCH reception. This may be achieved by UE measurement and reporting of CSI based on the signals corresponding to the activated DL TCIs. The network may then switch to the best DL TCI based on such “second-stage” CSI reports.

The reporting rate of such second-stage CSI reports should typically be higher than of first-stage CSI reports since fast channel variations, e.g., small scale fading, UE rotation, temporary blocking, may be countered by fast DL TCI switching using DCI. The MAC CE activation of subsets of DL TCIs, on the other hand, is slower and could account for slower variations, e.g., due to large scale fading.

However, in state-of-the-art systems, there is no direct link between a set of activated DL TCIs and a set of DL RS on which a UE performs CSI measurement and reporting. This means that it is up to the network to maintain such a set of DL RS that would correspond to a set of activated DL TCIs, at the cost of additional signaling overhead and latency. Similarly, in state-of-the-art systems, there is no direct link between a set of activated UL TCIs and a set of DL RS on which a UE performs CSI measurement and reporting, which also means it is up to the network to maintain such a set of DL RS that would correspond to a set of activated UL TCIs, at the cost of additional signaling overhead and latency.

Fast UL TCI switching using DCI, e.g., selection of a TCI codepoint, may be possible only between a subset of the configured UL TCIs. For example, only a UL TCI among the activated UL TCIs may be selected, where the UL TCIs may have been activated by one or more MAC CEs.

In general, it may be beneficial if the network switched the UL TCI such that the used UL TCI would always correspond to the best UL TCI, e.g., in terms of radio link reliability, radio link throughput, system performance and interference, etc. To facilitate such switching, the network may need UL CSI corresponding to the different UL TCIs.

The network may need to make sure that a sufficiently good UL TCI among the activated UL TCIs is actually used for PUCCH/PUSCH transmission. This may be achieved by UE transmission of SRS corresponding to the activated UL TCIs and corresponding measurements at the network side. The network may then switch to the best UL TCI based on such measurements.

The transmission periodicity of such SRS should typically be short since fast channel variations, e.g., small scale fading, UE rotation, temporary blocking, may be countered by fast UL TCI switching using DCI.

However, in state-of-the-art systems, there is no direct link between a set of activated UL TCIs and an SRS resource set transmitted by the UE and measurement by the network. This means that it is up to the network to maintain such an SRS resource set that would correspond to a set of activated UL TCIs, at the cost of additional signaling overhead and latency. Similarly, in state-of-the-art systems, there is no direct link between a set of activated DL TCIs and an SRS resource set transmitted by the UE and measurement by the network. This means that it is up to the network to maintain such an SRS resource set that would correspond to a set of activated DL TCIs, at the cost of additional signaling overhead and latency

According to some aspects, UEs in a state with an RRC configuration, e.g., RRC_CONNECTED state, are considered herein. Solutions herein may be applied to a BWP in a serving cell, multiple BWPs in a serving cell, a single BWP (e.g., with a certain BWP Id) in multiple serving cells (e.g., serving cells in a configured list of serving cells), multiple BWPs in multiple serving cells, all BWPs in multiple serving cells.

Activated TCIs correspond to TCI codepoints of a TCI field in a DCI. Unless otherwise noted, a codepoint herein corresponds to such a TCI codepoint.

According to some apsects, a CSI-RS (e.g., NZP-CSI-RS) may be used for multiple purposes. Different purposes may also be associated with different CSI-RS configurations. A few examples are given below:
(1) CSI-RS for tracking, also called tracking RS (TRS): a CSI-RS resource set may be configured as a TRS if it is configured with a certain parameter, e.g., trs-Info. In state-of-the-art systems, CSI feedback based on aperiodic TRS is not supported. This is also the assumption in various examples herein. In other examples, CSI feedback based on TRS, e.g., periodic TRS, is considered;
(2) CSI-RS for beam management (BM): Even though other CSI-RS may be used for beam management, the term CSI-RS for BM is typically used for a CSI-RS resource set with a certain parameter configured, e.g., repetition. The parameter may be configured as on, meaning that CSI-RS repetition is applicable for the CSI-RS resource set. The parameter may also be as off, meaning that repetition is not applicable; and
(3) CSI-RS for CSI: CSI-RS that is not a TRS or CSI-RS for BM may be a CSI-RS for CSI, e.g., it is not configured with trs-Info or repetition. Note that CSI-RS for CSI may be useful for beam management and CSI-RS for BM may be configured for CSI measurement and feedback.

In general, RS (e.g., CSI-RS) is considered for channel measurement herein, unless otherwise noted. For an interference measurement, a UE may apply the QCL assumption used for the corresponding channel measurement.

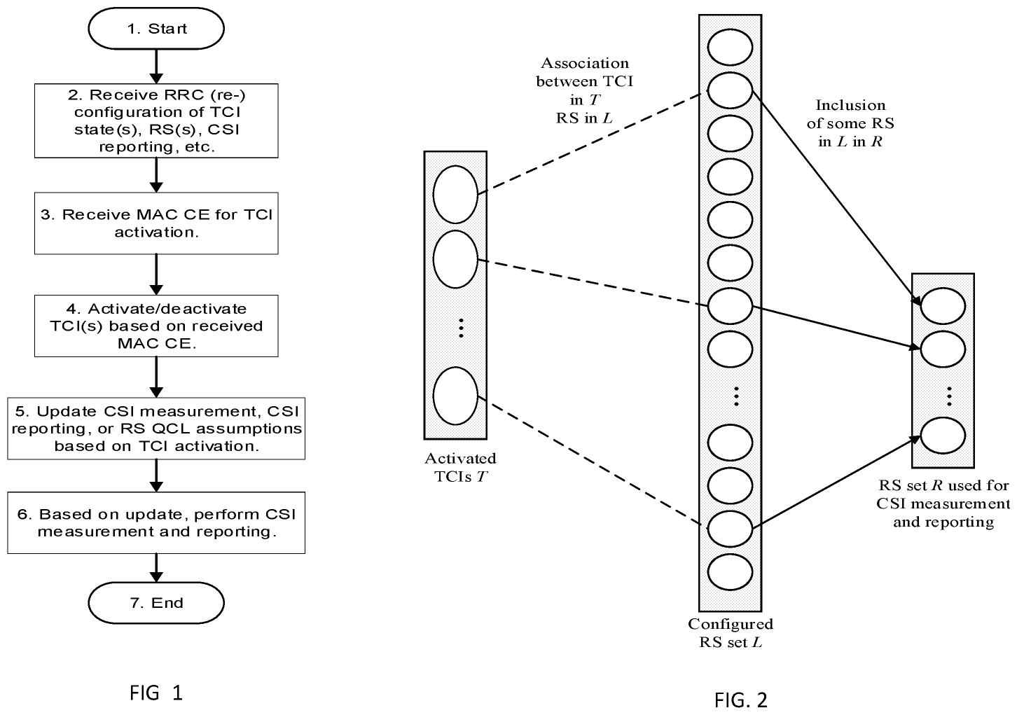

A high-level description of a UE procedure is illustrated in FIG. 1. The illustrated steps are disclosed below:
(Step 1) The procedure starts.
(Step 2) The UE receives an RRC configuration or reconfiguration, including for example configuration for TCI state pool(s), RS resources (e.g., CSI-RS), CSI reporting, and/or enabling of updating of CSI, TCI, etc. (as described herein) based on TCI activation. Note that the UE may receive an RRC reconfiguration from the network at any time, thereby returning to this step. An RRC reconfiguration may reconfigure a part of the configuration.
(Step 3) The UE receives a MAC CE for TCI activation. As a result, some configured TCI(s) may be activated while other TCI(s) may be deactivated, as captured in the next step. Henceforth in the description, it is assumed that more than one TCI is activated, but the solutions are also applicable to the case that the network activates only a single TCI. The TCI activation may apply to a single BWP, multiple BWPs in a single serving cell (e.g., a group of BWPs), a single BWP (e.g., with a certain BWP Id) in multiple serving cells (e.g., serving cells in a configured list of serving cells), multiple BWPs (e.g., a group of BWPs) in multiple serving cells, all BWPs in multiple serving cells etc. Note that the UE may receive a MAC CE for TCI activation from the network at any time, thereby returning to this step.
(Step 4) Following MAC CE reception, the corresponding TCI(s) are activated/deactivated. The UE typically needs some time between the reception of the PDSCH that carries the MAC CE (or the corresponding acknowledgement) and time the corresponding TCI activation/deactivation. A set of activated TCIs may be denoted T.

In various examples, T may refer to DL-related activated TCIs. For example, T may include activated joint DL/UL TCI or activated separate DL/UL TCI, e.g., a TCI codepoint that corresponds to both a DL TCI and a UL TCI which may correspond to the same (for joint DL/UL TCI) or different (for separate DL/UL TCI) spatial source RS (e.g., beam). T may also include activated separate DL TCI (e.g., DL-only TCI), e.g., a TCI codepoints that does not correspond to a UL TCI, which may mean that the applied UL TCI is not updated if the separate DL TCI is indicated, e.g., in a DCI.

In some examples, duplicates are not included in T, e.g., if the same DL RS is a source RS in multiple activated TCIs, it is only included once in T. In other examples, duplicates are kept in T.

In various examples, T may refer to both DL-related and UL-related activated TCIs, e.g., all activated TCIs. For example, T may include activated joint DL/UL TCI, separate DL/UL TCI, DL-only TCI, and UL-only TCI. In some cases, TCIs (e.g., separate UL TCIs) including a UL RS as a UL spatial reference are not included in T.
(Step 5) Upon the activation/deactivation of a new set of TCIs, the UE performs other updates related CSI measurement and/or reporting. The details of how this update is performed may be based on the RRC configuration. Various examples of this step are disclosed herein.
(Step 6) The UE performs CSI measurement and reporting, based on the RRC configuration and the updates in the previous step. Other MAC CEs, e.g., activation of SP CSI reporting, and DCIs, e.g., AP CSI triggering, may also affect the CSI measurement and reporting. Various examples will be disclosed further below.
(Step 7) Procedure ends.

Step 2 may be preceded by UE capability signaling, e.g., transmission of UE capability information to the network, conveying that the UE supports various functionalities described herein, such as update of CSI measurement/reporting based on TCI activation.

From the base station (BS) perspective, the steps above may include the following:
(Step 1) The procedure starts.
(Step 2) The BS transmits an RRC configuration or reconfiguration to a UE.
(Step 3) The BS transmits a MAC CE for TCI activation to the UE.
(Step 4) Following MAC CE reception, the corresponding TCI(s) are activated/deactivated for the UE.
(Step 5) Upon the activation/deactivation ofa new set of TCIs for the UE, the BS may perform other updates related to RS transmission and/or interpretation of reporting, e.g., corresponding to the updates that the UE performs.
(Step 6) The BS transmits RSs and interprets CSI report(s) from the UE based on the updates in the previous step. The gNB may indicate a new TCI (e.g., in DCI), or activate a new set of TCI states (e.g., in a MAC CE), based on these CSI report(s).
(Step 7) Procedure ends.

The enabling of various functionalities described herein by the network in step 2d above may comprise the inclusion of an RRC parameter in an RRC information element (IE), e.g., the CSI measurement configuration (e.g., CSI-MeasConfig) IE or in a CSI reporting configuration/setting (e.g., CSI-ReportConfig). The enabling may also involve certain settings of existing parameters as disclosed herein. In another example, the enabling may also involve the absence of one or more parameters in a configuration.

In various examples disclosed herein, a subset (e.g., one) of the CSI reporting settings may be configured such that an associated set of resources (e.g., one or more resource sets) or TCI states is updated upon TCI activation or based on the set of activated TCIs. CSI for the other CSI reporting settings may follow legacy procedures, e.g., might not be affected by TCI activation.

In a CSI reporting setting, if a parameter (e.g., CSI-BasedOnActivatedTCI) is configured, or configured to a certain value (e.g., ‘on’), then the functionality is to be used, e.g., the corresponding resources, e.g., for channel measurement, are to be based on the activated TCI states.

In one example, the dummy parameter in the Rel-16 IE CSI-ReportConfig is repurposed for this functionality.

In a CSI reporting setting, if the resource setting ID (e.g., CSI-ResourceConfigId), e.g., for channel measurement, is set to a certain value, then the functionality is to be used, e.g., the corresponding resources, e.g., for channel measurement, are to be based on the activated TCI states. Examples of such a value are disclosed below:
(1) The value is 0;
(2) The value is the maximum value (e.g., maxNrofCSI-ResourceConfigurations-1);
(3) The value is a certain configured value. For example, the RRC parameter (e.g., in the CSI measurement configuration) that enables the functionality at hand also configures the resource setting ID value that indicates that the functionality is to be used for the CSI reporting setting; and
(4) The value is a value that does not correspond to a configured CSI resource setting. Unless the maximum number of CSI resource settings have been configured, some resource setting IDs are unused. The indication of such an ID may indicate that the functionality is to be used.

In a CSI reporting setting, if the resource setting ID (e.g., CSI-ResourceConfigId), e.g., for channel measurement, corresponds to CSI resource setting with a certain configuration, then the functionality is to be used, e.g., the corresponding resources, e.g., for channel measurement, are to be based on the activated TCI states. Examples of such a configuration are disclosed below:
(1) A parameter (e.g., CSI-BasedOnActivatedTCI) is configured in the CSI resource setting, or configured to a certain value (e.g., ‘on’).
(2) The list of resource set IDs, e.g., for channel measurement comprises a certain set of resource set IDs, for example:

The set of resource set IDs includes 0, e.g., it includes only 0.

The set of resource set IDs includes the maximum value (e.g., maxNrofCSI-SSB-ResourceSets-1), e.g., it includes only the maximum value.

The set of resource set IDs includes a certain configured value, e.g., it includes only the configured value. For example, the RRC parameter (e.g., in the CSI measurement configuration) that enables the functionality at hand also configures the resource set ID value that indicates that the functionality is to be used for the CSI reporting setting.

The set of resource set IDs includes a value that does not correspond to a configured CSI resource set, e.g., it includes only a value that does not correspond to a configured CSI resource set. Unless the maximum number of CSI resource sets have been configured, some resource set IDs are unused. The indication of such an ID may indicate that the functionality is to be used.

The set of resource set IDs is empty, e.g., no NZP-CSI-RS-ResourceSetId and no CSI-SSB-ResourceSetId is configured for the resource set list (e.g., parameter csi-RS-ResourceSetList).

(3) A resource set (e.g., NZP-CSI-RS-ResourceSet or CSI-SSB-ResourceSet), with resource set ID in the list of resource set IDs, is configured in a certain way, for example as below. In some cases, the functionality is applied only if the resource set with certain configuration is to be used, e.g., for channel measurement, for instance based on an indicated AP trigger state.

A parameter (e.g., CSI-BasedOnActivatedTCI) is configured in the resource set, or configured to a certain value (e.g., ‘on’).

The list of resource IDs, comprises a certain set of resource IDs, for example:
(a) The set of resource IDs includes 0, e.g., it includes only 0.
(b) The set of resource IDs includes the maximum value (e.g., maxNrofNZP-CSI-RS-Resources-1 or maxNrofCSI-SSB-ResourceSets-1), e.g., it includes only the maximum value.
(c) The set of resource set IDs includes a certain configured value, e.g., it includes only the configured value. For example, the RRC parameter (e.g., in the CSI measurement configuration) that enables the functionality at hand also configures the resource ID value that indicates that the functionality is to be used for the CSI reporting setting.
(d) The set of resource IDs includes a value that does not correspond to a configured CSI resource, e.g., it includes only a value that does not correspond to a configured CSI resource. Unless the maximum number of CSI resources have been configured, some resource IDs are unused. The indication of such an ID may indicate that the functionality is to be used.

In state-of-the-art systems, a resource set may include a set of configured resources. Updating the set of configured resources in a resource set may require a reconfiguration, which may be costly in terms of overhead and latency.

According to some aspects, the update of a resource set may be based on a TCI activation. A TCI activation is an update of the set of activated TCIs, denoted T. In a first example, a resource set may be updated upon TCI activation. In a second example, a resource set may be updated when it is to be used, e.g., upon SP resource activation or triggering of an AP resources, based on the currently activated TCIs T. From a functional point of view, the first and second examples may be equivalent. It may be up to a UEs implementation if a resource set is updated directly upon TCI activation or not until the resource set is to be used. For brevity, the description uses the first example, but the embodiments are also readily applicable to the second example.

In some cases, there may be multiple sets of activated TCIs in a BWP or a serving cell. For example, if there are multiple CORESET pools configured in BWP or a serving cell, there may be a set of activated TCIs per CORESET pool. For example, with two pools, there may be two sets of activated TCIs, denoted T1 and T2. Various example solutions here may be applied separately to one of the sets or both of the sets, e.g., T may be T1 and/or T2. The example solutions may also be to the union of the two sets.

In some cases, a CSI reporting setting may be associated with a CORESET pool (or TRP), for example through an associated PUCCH resource (e.g., a PUCCH resource configured to be used for CSI reporting). PUCCH resources may be grouped (e.g., by RRC configuration) and each group may be associated with a CORESET pool, TRP or TRP-related index. In some cases, a CSI measurement and report are associated with a CORESET pool through the DCI that carried the aperiodic CSI trigger or the activation of semi-persistent CSI or semi-persistent CSI-RS. For example, the UE may use as T the set of TCIs (e.g., T1 or T2) associated with the CORESET pool (or TRP) to which the CORESET on which the DCI was received belongs.

In some cases, e.g., group-based CSI reporting, a CSI report carries one or more pairs of report quantities (e.g., SSBRI or CRI values, L1-RSRP, etc.) where the first part of the pair corresponds to an RS in a first resource set, while the second part of the pair corresponds to a second resource set. The methods herein may be applied to such reporting, for example by updating the first resource set (or corresponding TCI states) based on a first set of activated TCIs (e.g., T1), while the second resource set (or corresponding TCI states) may be updated based on a second set of activated TCIs (e.g., T2).

In some cases, only activated TCIs applicable to DL are considered, e.g., joint TCI or DL-only TCI. If so, T may include only activated TCI states applicable to DL.

A TCI may comprise one or two source RS for DL TCI. For example, there may be one source RS with QCL typeA, e.g., a TRS, and a source RS with QCL typeD, e.g., a TRS or a CSI-RS for BM.

In some cases, activates TCIs applicable to both DL and UL are considered here, e.g., joint TCI, separate DL/UL TCI, DL-only TCI, or UL-only TCI. If so, T may include all activated TCIs. However, some TCIs may be excluded from T such as TCIs with a UL RS as UL spatial reference.

Periodic CSI may be reported on PUCCH. In some cases, e.g., when the PUCCH overlaps in time with a PUSCH, the CSI may be multiplexed in the PUSCH instead. Periodic CSI may be based on a periodic RS, e.g., periodic CSI-RS or SSB.

In state-of-the-art systems, the TCI state of a periodic CSI-RS may be RRC configured, while an SSB does not have a TCI state. Hence, it may be more suitable to update the set of periodic RS associated with a CSI reporting setting than to update the TCI states of a set of periodic RS associated with a CSI reporting setting. The set of RSs (e.g., periodic or semi-persistent RS) associated with a CSI reporting setting, herein denoted R, may be the RSs for which measurements are used for the corresponding CSI report(s), e.g., on PUCCH. In state-of-the-art systems, for example, R may be configured in csi-RS-ResourceSetList in the CSI-ResourceConfig IE.

In various examples herein, an RS from a TCI in T is used to determine an RS in R. If T comprises two source RS, one of the source RS may be used to determine an RS in R. In one example, the source RS with QCL typeA may be used. In another example, the source RS with QCL typeD may be used. In yet another example, either source RS may be used. In yet another example, both source RS may be used, in which case one or two RS in R may be determined.

The set of RSs R may include all or a subset of the RSs in all or a subset of the activated TCIs T. For simplicity, consider one source RS per TCI being applicable for inclusion in R, as disclosed above.

In some cases, the source RS for each activated TCI in T may be used for the corresponding configured CSI report. This may be the case for example if CSI measurement and reporting based on TRS is supported for the corresponding configured CSI report, e.g., with quantity L1-RSRP. In this case, R may comprise the corresponding source RSs in T.

In some cases, the source RS for a subset of the activated TCIs in T cannot be used for the corresponding configured CSI report. This may be the case for example if CSI measurement and reporting based on TRS is not supported for the corresponding configured CSI report. In this case, R may comprise the remaining source RSs in T, e.g., the source RSs for which the CSI measurement and reporting is supported.

If a source RS (the first RS) in an activated TCI in T cannot be used for the corresponding CSI report, perhaps a second RS that is source RS for the first RS may be used. In other words, the first RS is both a source RS (since it is included in the activated TCI) and a target RS. This may be called a QCL chain, where multiple source/target RS form a chain of QCL relations.

A direct source RS to a first RS may be an RS (the second RS) that has a direct QCL relation with the first RS, e.g., by being included in an activated TCI for the first RS. An indirect source RS to a first RS may be an RS (a third RS) that is a direct source RS to the second RS, but not to the first RS. The QCL chain may be even longer with even more steps (of direct QCL relations) between the source RS and the indirect source RS.

An example procedure to include RSs in R is as follows:

```
For each TCI in T:
  The RS r is a source RS in the TCI.
  (1) If r can be included in R (e.g., it may be used for the corresponding
CSI measurement and report):
    Include r in R
    Break (e.g., go to the next TCI)
  Else (e.g., r cannot be included in R):
    If the RS r has a source RS r’:
      The RS r is set to r’
      Go to (1)
    Else (e.g., r is an SSB)
      Break (e.g., go to the next TCI)
End
```

According to some aspects, another way to solve this is to consider another set of RSs L for potential inclusion in R. L may be a set of RSs that may be included in R, e.g., they may be of the proper type. The set L may be seen as a set of candidate RS for inclusion in the set R used for CSI measurement and reporting. In one example, L may be configured using a CSI resource setting, e.g., one or more resource sets in csi-RS-ResourceSetList. In the example that L is configured using multiple resource sets in the CSI resource setting, L may comprise the union of the RSs. In another example, L may be configured separately, e.g., in CSI-MeasConfig. In one example, multiple sets L₁, L₂, etc., may be configured and the CSI reporting setting may refer to one the sets, e.g., by configuring an ID of such a set. For example, a first set is configured to comprise RSs suitable for a first kind of CSI report, e.g., L1-RSRP reports, while a second set is configured to comprise RSs suitable for a second kind of CSI report, e.g., CRI, RI, PMI, and CQI.

In one example, the functionality disclosed herein is enabled for a CSI reporting setting if the CSI reporting setting configured such a reference to a set L, e.g., the i^{th} set Lᵢ.

However, unlike in state-of-the-art systems, all the configured RSs in L might not be used for CSI measurement and reporting. For example, RSs in L that are linked with RSs in T may be included in R, where the linking may be based on QCL relations. In another example, a link between a TCI state and an RS may be configured in a TCI state, e.g., with an optional RS ID in a TCI state configuration. A TCI state may be linked with multiple RS, e.g., by including a list of RS IDs. In yet another example, a link between a TCI state and an RS may be configured in an RS configuration, e.g., with an optional TCI state ID in an RS configuration. An RS may be linked with multiple TCI states, e.g., by including a list of TCI state IDs.

An exemplary embodiment is illustrated in FIG. 2. The set of RS L in the middle may be RRC configured, where a circle may correspond to an RS. The set of activated TCIs T to the left may be dynamically updated, where an ellipse may correspond to a TCI, e.g., joint DL/UL TCI, separate DL/UL TCI, DL-only TCI, or (in some examples) UL-only TCI. For a particular set T, an RS set R can be selected from the RS set L (with R typically being a smaller or significantly smaller set than L), based on some association or linking between TCIs in T and some RSs in L. As a new set of TCIs T is activated, the RS set R may be automatically updated, thereby saving both RRC reconfiguration overhead and latency and potentially also CSI measurement effort by the UE (which may save UE battery power) and potentially also CSI reporting resources, which may save both UE power and improve network efficiency.

An RSs in L may be configured with one or two QCL source RS(s), e.g., in a configured TCI state.

Various examples of the determination of RS(s) in R are described below.

General example: A first RS that is in L is included in R if the first RS is associated with a TCI in T.

A first RS that is in L is included in R if the TCI state configured for first RS is in T.

The TCI state configured for the first RS being in Tmay for example comprise one of the following:
(1) The TCI state ID configured for the first RS is the same as a TCI state ID corresponding to a TCI state in T, e.g., the TCI state from which the joint TCI, DL TCI or the UL TCI is taken;
(2) The one or two source RS in the TCI state configured for the first RS are the same as the one or two source RS in a TCI in T;
(3) A source RS in the TCI state configured for the first RS is the same as a source RS in a TC in T, and
(4) A source RS with a specific QCL type (e.g., typeA, typeC, type D, or typeD when applicable and otherwise typeA) in the TCI state configured for the first RS is the same as a source RS with the same type in a TC in T.

For example, a CSI-RS resource in L has TCI state #5 configured as QCL source, e.g., with parameter qcl-InfoPeriodicCSI-RS. If TCI state #5 is in the set of activated TCI T, then the CSI-RS resource is included in R.

A first RS that is in L is included in R if the TCI state configured for the first RS or an indirect TCI state of the first RS is in T.

An indirect TCI state of the first RS may be a TCI state of a (direct) QCL source RS of the first RS. An indirect TCI state of the first RS may also be a TCI state of a source RS in another indirect TCI state of the first RS.

A first RS that is in L is included in R if the TCI state configured for the first RS or an indirect TCI state of the first RS is in Tor is a direct or indirect TCI state to an RS in a TCI in T.

For example, a CSI-RS in L has TCI state #5 configured as QCL source, but TCI state #5 is not in T. However, an RS included in TCI state #5 has TCI state #1 configured as QCL source. TCI state #6 is included in T. Since an RS in TCI state #6 also has TCI state #1 configured as QCL source, the CSI-RS is included in R. TCI state #5 and #6 may for instance include different TRS, while TCI state #1 may for instance include an SSB.

A first RS that is in L is included in R if a direct or indirect QCL source RS of the first RS is in TCI Tor is a direct or indirect QCL source RS of an RS in a TCI in T.

In some cases, source RS of a specific type is considered (e.g., typeA, typeC, type D, or typeD when applicable and otherwise typeA).

For example, a CSI-RS in L has SSB #9 as indirect QCL typeD source. Since an RS in a TCI Talso has SSB #9 as indirect QCL typeD source, the CSI-RS is included in R.

In some cases, the method to include RSs in R, e.g., as described above, may result in a number of RSs that exceeds a maximum number of RSs for R. The maximum number may be determined for instance by the maximum number supported by the signaling protocol, a reported UE capability, or a maximum number described in the specification for a certain case, such as the maximum number of RSs in CSI resource set for the number of antenna ports of the CSI-RS in L and R.

If so, not all RSs can actually be included in R. The UE may select which RSs to actually include in R based on one or more criteria, for example: RS type: if SSBs and CSI-RS are to be included, one type may be prioritized, e.g., SSBs; RS transmission periodicity: RSs with shorter periodicity may be prioritized; RS resource ID: RSs with lower resource ID or RSs with higher resource ID may be prioritized; TCI state ID: RSs associated with TCI states with lower TCI state ID or with higher TCI state ID may be prioritized; TCI codepoint: RSs associated with TCIs corresponding to lower TCI codepoint value or higher TCI codepoint value may be prioritized; and/or TCI currently used for PDCCH/PDSCH is prioritized, e.g., corresponding RSs are included first in R.

In some cases, the maximum number may be exceeded if one or more TCIs in Tare associated with multiple RSs in L, which then may be included in R. One way to solve the issue is to include in R at most one RS from L that is associated with the same TCI in T. If multiple RSs are associated with a TCI, one or more criteria may be used to select one RS.

In some cases, the inclusion of RSs in R is based on which TCI is currently being used for (is applicable to) PDCCH/PDSCH, e.g., it is the latest TCI that has been indicated by a DCI and subsequently been applied to PDCCH/PDSCH after a certain delay. In some examples, there are multiple currently used TCIs, e.g., in the case of multiple CORESET pools. A currently used TCI may be denoted current TCI. In some cases, a currently used TCI is associated with other activated one or more TCI(s), denoted secondary TCI(s). The secondary TCI(s) may be explicitly associated with the current TCI, e.g., by additional information in the MAC CE that activates TCIs. Alternatively, the potentially associated TCIs may be RRC configured, e.g., by TCI state grouping (activated TCIs corresponding to the same group may be associated). In other cases, the associated is implicit, e.g., based on the codepoint values of the activated TCIs. For example, the TCIs with codepoint values adjacent to a current TCI may be secondary TCIs. The codepoint 0 may be considered adjacent to the highest activated codepoint value, and vice versa. In some cases, RS(s) in the current TCI and in the secondary TCI(s) are included in R. In some cases, an RS in the current TCI is included first in R, and RS(s) in secondary TCI(s) are included second. In some cases, only RS(s) in TCI(s) in secondary TCI(s) are included in R. This may be useful if the RS in the current TCI is included in R elsewhere, e.g., for another CSI reporting setting or CSI resource configuration.

Also semi-persistent CSI may be reported on PUCCH. Semi-persistent CSI may be based on periodic and/or semi-persistent RS, e.g., SSB, periodic CSI-RS and/or semi-persistent CSI-RS. Solutions for periodic CSI disclosed herein may also be applicable to semi-persistent CSI, for example semi-persistent CSI based on periodic RS and/or activated semi-persistent CSI-RS. For an activated semi-persistent CSI-RS, the TCI state may have been indicated in the activation MAC CE. Solutions herein described for periodic CSI-RS may apply to activated semi-persistent CSI-RS by considering the indicated TCI state as the TCI state of the RS.

A UE may perform beam failure detection (BFD) on a serving cell. This may involve measurements of a set of RS for BFD (BFD-RS). As a UE moves, the network may need to perform RRC configurations to maintain an up-to-date set of BFD-RS. Solutions herein applicable to a set of RS for CSI measurement and reporting may be applied to a set of BFD-RS. For example, a set of BFD-RS may be updated upon TCI activation.

In various cases, BFD is based on currently used beams for CORESETs. An extended BFD operation may consider beam failure detection based on a larger set of RSs, such as a set of RSs associated with or included in a set of activated TCIs, e.g., according to various examples herein. A benefit of such an enhancement may be to have the UE detect a deteriorated link quality of activated TCIs and provide an indication to the network about this. The network may then react with for example triggering of CSI, activation of a new set of TCIs, etc., in order to avoid beam failure or radio link failure.

Aperiodic (AP) CSI may be triggered by a DCI indicating one out of typically multiple AP trigger states. The AP trigger states are RRC configured. A subset of the triggered AP trigger states may be mapped to codepoints in the DCI by a MAC CE. In other words, a DCI may select an AP CSI from a subset of the configured AP trigger states. AP CSI may be reported in a PUSCH. For semi-persistent CSI, it may also be reported on PUSCH. Semi-persistent CSI on PUSCH may be similar to aperiodic CSI since a DCI may select one out of multiple trigger states. Hence, solutions described herein may be applied to both aperiodic CSI and semi-persistent CSI on PUSCH.

An AP trigger state may be associated with one or multiple CSI reporting settings. Each of the associated CSI reporting settings may be associated with one or more resource sets for channel measurement, which may be periodic, semi-persistent or aperiodic. In case of a periodic CSI-RS resource set, the corresponding TCI states may be RRC configured per resource, as also described for periodic CSI. For a semi-persistent CSI-RS resource set, the TCI states of the resources may be indicated in the activation command. For aperiodic CSI-RS the TCI states of the CSI-RS resources may be configured in the AP trigger state directly.

In some cases, an aperiodic CSI-RS resource can be configured to use the same TCI that is used for UE-specific PDCCH/PDSCH in the unified TCI framework. This may be achieved by a certain configuration in the AP trigger state. For example, a parameter is added to the trigger state to indicate that all resources in the aperiodic CSI-RS resource sets for channel measurement use the same TCI as for UE-specific PDCCH/PDSCH. In another example, the use of the TCI is configured per CSI-RS resource set. For example, it can be indicated by the omission of a TCI state configuration for an aperiodic CSI-RS resource set (e.g., parameter qcl-info may be absent in a CSI-AssociatedReportConfigInfo). In another example, it is indicated by a separate optional parameter per CSI-RS resource set for channel measurement, where presence of the parameter or a certain parameter value indicates that the resources in the CSI-RS resource set should use same TCI as is used for UE-specific PDCCH/PDSCH.

According to an aspect, it may be indicated or configured to a UE that some aperiodic CSI-RS resources are to use one or more of the activated TCIs in Tas QCL source.

In various examples, similar solutions may be used for indicating that a trigger state, resource set or resource should use the TCI that is also used for UE-specific PDCCH/PDSCH, as outlined below.

In some cases, an aperiodic CSI-RS resource can be configured to use a TCI in T. This may be achieved by a certain configuration in the AP trigger state. For example, a parameter is added to the trigger state to indicate that all or a subset of resources in the aperiodic CSI-RS resource sets for channel measurement use TCI(s) in T. A parameter may also be added to an associated reporting config, e.g., CSI-AssociatedReportConfiglnfo.

In another example, the use of a TCI in Tis configured per CSI-RS resource set, e.g., in an associated reporting config (e.g., CSI-AssociatedReportConfiglnfo) or in a CSI resource configuration (e.g., CSI-ResourceConfig). For example, it can be indicated by the omission of a TCI state configuration for an aperiodic CSI-RS resource set (e.g., parameter qcl-info may be absent in a CSI-AssociatedReportConfiglnfo). In another example, the TCI state configuration is present but has a certain configuration. For example, it may indicate a single TCI state ID with a certain value, e.g., 0, where the ID might not be corresponding to any configured TCI state.

In yet another example, the use of TCI(s) in Tfor an AP CSI-RS resource set may be configured in the CSI resource configuration corresponding to a CSI reporting setting. For instance, a list of indications of the same length as the number of AP CSI-RS resource sets configured (for channel measurement) in the CSI resource configuration may be configured, where an indication indicates that TCI(s) in Tcan be used for the corresponding CSI-RS resource sets.

In some cases, a CSI-RS resource may not be configured with a TCI state, if it is also configured that the CSI-RS resource set (containing the resource) is to use a TCI in T. In other cases, a CSI-RS resource may be configured with a TCI state, even if it is in a resource set configured to use TCI(s) in T.

If the number of TCIs in Tis the same as the number of CSI-RS resources (for channel measurement) in an associated CSI reporting configuration of the AP trigger state, each TCI in T can be mapped to a CSI-RS resource. For example, the TCI in T corresponding to the lowest codepoint (among the TCIs in 7) may be mapped to the first CSI-RS resource in the resource set (e.g., the first entry in nzp-CSI-RS-Resources of that NZP-CSI-RS-ResourceSet), etc.

If the number of TCIs in Tis greater than the number of CSI-RS resources, a subset of the TCIs in T map be mapped to the CSI-RS resources. The same mapping order as for equal numbers may be followed, resulting in that one or more TCI in Tcorresponding to the highest TCI codepoints are not mapped to CSI-RS resources.

If the number of TCIs in Tis smaller than the number of CSI-RS resources, there are several options.

For example, TCIs in Tare mapped (once) to the first CSI-RS resources. The remaining CSI-RS resources may use configured TCI states (e.g., by parameter qcl-info may be absent in a CSI-AssociatedReportConfiglnfo).

In another example, the TCIs in Tare mapped to all CSI-RS resources (for the associated reporting configuration of the AP trigger state) in a round-robin fashion, e.g., after the last TCI in T (e.g., corresponding to the highest codepoint) has been mapped to a CSI-RS resource, the first TCI in Tis mapped to the next CSI-RS resource etc.

In yet another example, TCIs in Tare mapped (once) to the first CSI-RS resources. The remaining CSI-RS resources are not triggered, e.g., the UE is not expected to measure and report CSI for those resources. This means that the TCI may be (e.g., temporarily) undefined for those CSI-RS resources. Note that the next time the AP trigger state is triggered, the number of TCIs in Tmay have been changed, perhaps resulting in triggering of CSI-RS resources that weren't triggered by the previous trigger.

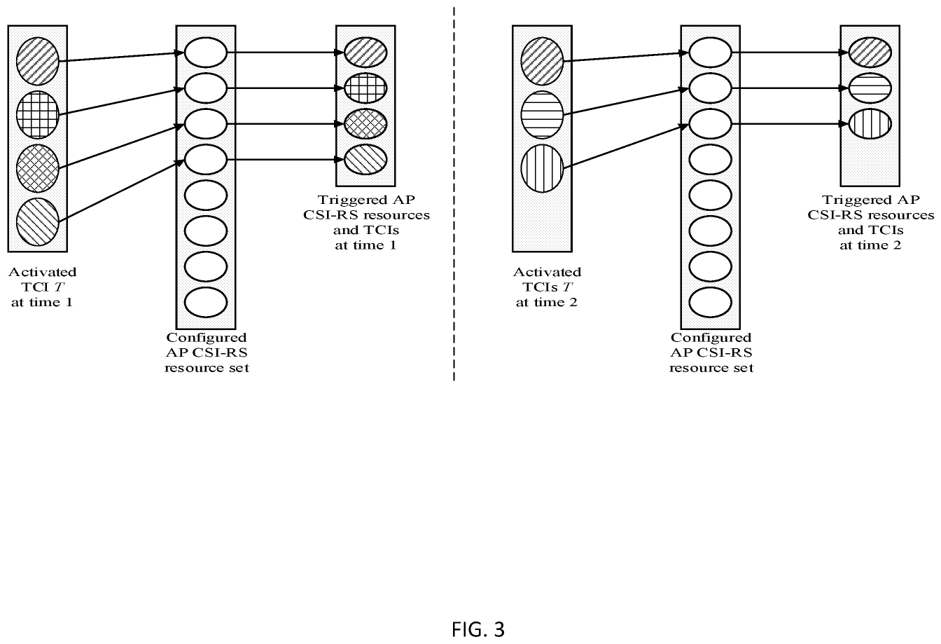

An exemplary illustration is shown in FIG. 3. The process to determine triggered AP CSI-RS resource from the activated TCIs Tand a set AP CSI-RS resources is shown at two different times, time 1 and time 2. The triggering of an AP trigger state with an associated reporting configuration with 8 configured CSI-RS resources in an AP CSI-RS resource set is considered. At time 1, Tcomprises 4 TCIs, so 4 CSI-RS resources are triggered, with each of the 4 TCI s in Tbeing used for a triggered CSI-RS resource. The different patterns signify different TCIs. At time 2, the set of TCIs Tis different. Firstly, there are only 3 activated TCIs. Secondly, the second and third TCIs have been changed, as illustrated by the different patterns. The first TCI is unchanged between time 1 and time 2. Consequently, 3 CSI-RS resources are actually triggered, with the corresponding TCIs in Tbeing used.

Another approach may be to configure per CSI-RS resource whether a TCI in T should be used. If so, a TCI may not be configured for the CSI-RS resource in some cases. In other cases, a CSI-RS resource may be configured with a TCI state and also to use a TCI in T (e.g., how to solve this ambiguity is disclosed in various examples below).

For example, a certain TCI state ID configured for a CSI-RS resource in a CSI-RS resource set for channel measurement (e.g., in an associated reporting configuration for an AP trigger state) indicates that a TCI in T should be used. In another example, different TCI state IDs may correspond to different TCIs in T. A certain value range of TCI state ID may be used for this purpose (e.g., 0-7), or any TCI state IDs that have not been used for a configured TCI state. The lowest TCI state ID (of those used to indicate that a TCI in Tis to be used for the CSI-RS resource) may indicate that the TCI in T corresponding to the lowest codepoint should be used, etc.

In another example, a separate list of indications of the same length as the number of AP CSI-RS resource sets configured (for channel measurement) in an associated CSI reporting configuration (e.g., CSI-AssociatedReportConfigInfo) may be configured, where an indication indicates that a TCI(s) in T can be used for the corresponding CSI-RS resource.

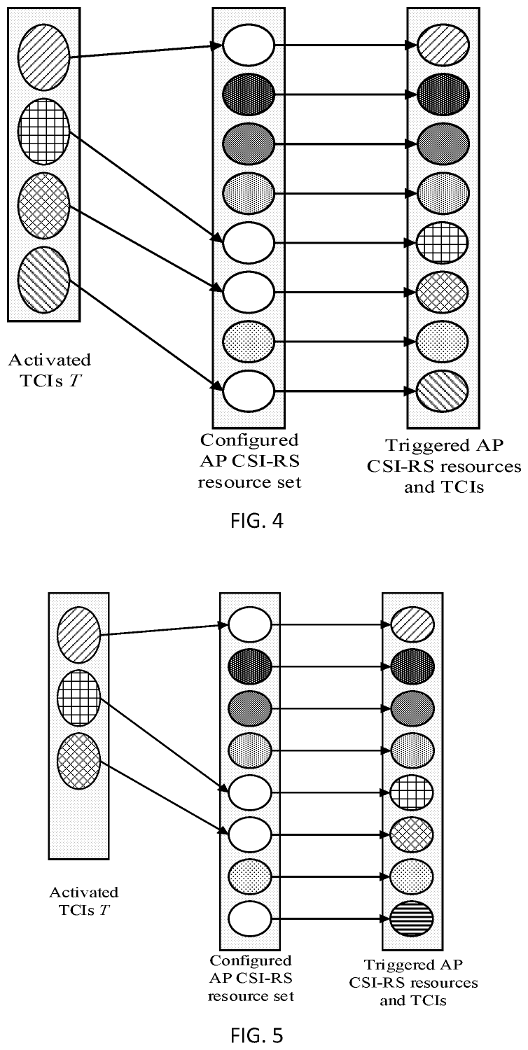

An exemplary illustration is shown in FIG. 4. Some CSI-RS resources in the AP CSI-RS resource set are configured to use a TCI in T (circles without pattern). Other CSI-RS resources may be configured to use a configured TCI state (circles with pattern). The result is that, when triggered, the UE may use activated TCIs in T for some CSI-RS resources, while configured TCI states for other CSI-RS resources.

If there are more TCIs in T than triggered CSI-RS resources (e.g., in an associated reporting configuration) that are to use the TCIs in T, only a subset of the TCIs in T may be used for the triggered CSI-RS resources, e.g., the TCIs in T that correspond to the lowest codepoints (e.g., lowest codepoint indices).

If there are fewer TCIs in T than triggered CSI-RS resources (e.g., in an associated reporting configuration) that are to use the TCIs in T, some of the CSI-RS resources may use a configured TCI state instead, e.g., the last entries in the list of CSI-RS resources in a CSI-RS resource set. This is illustrated in FIG. 5, where the last CSI-RS resource is configured to use a TCI in T. However, due to too few TCIs in T, the last CSI-RS resource uses a configured TCI state instead.

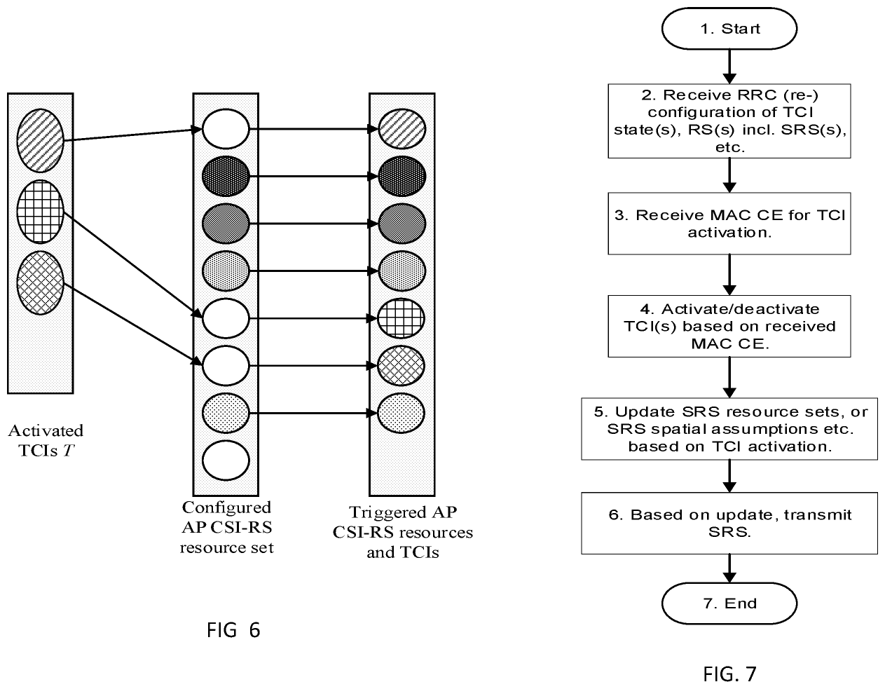

In another example, a CSI-RS resource in a triggered AP triggering state (e.g., in an associated reporting configuration) might not be triggered if it has been configured to use a TCI in T, but there are too few TCIs in T. Furthermore, in this case, a TCI state might not have been configured for the CSI-RS resource. An exemplary illustration is shown in FIG. 6, where the last CSI-RS resource is configured to use a TCI in T. However, due to too few TCIs in T, a TCI in Tis not assigned to the last CSI-RS resource and it is not triggered.

In some cases, which TCI(s) in T that are assigned to CSI-RS resources is based on the current TCI and/or secondary TCI(s) (e.g., see definition above). In some cases, the current TCI and the secondary TCI(s) are assigned to CSI-RS resources. In some cases, the current TCI is assigned first, and secondary TCI(s) are included second. In some cases, only TCI(s) in secondary TCI(s) are assigned. This may be useful if the current TCI is assigned to CSI-RS resources elsewhere, e.g., in another CSI reporting setting.

Various solutions herein address Problem 2 regarding SRS Update TCI State.

A high-level description of an exemplary UE procedure is illustrated in FIG. 7.

The steps are disclosed in detail below:
(Step 1) The procedure starts.
(Step 2) The UE receives an RRC configuration or reconfiguration, including for example configuration for TCI state pool(s), RS resources (e.g., CSI-RS and SRS), SRS triggering, and enabling of updating SRS TCI(s), etc. (e.g., as described herein) based on TCI activation. Note that the UE may receive an RRC reconfiguration from the network at any time, thereby returning to this step. An RRC reconfiguration may reconfigure a part of the configuration.
(Step 3) The UE receives a MAC CE for TCI activation. As a result, some configured TCI(s) may be activated while other TCI(s) may be deactivated, as captured in the next step. Henceforth in the description, it is assumed that more than one TCI is activated, but the solutions are also applicable to the case that the network activates only a single TCI. The TCI activation may apply to a single BWP, multiple BWPs in a single serving cell, a single BWP (e.g., with a certain BWP Id) in multiple serving cells (e.g., serving cells in a configured list of serving cells), multiple BWPs in multiple serving cells, all BWPs in multiple serving cells, etc. Note that the UE may receive a MAC CE for TCI activation from the network at any time, thereby returning to this step.
(Step 4) Following MAC CE reception, the corresponding TCI(s) are activated/deactivated. The UE typically needs some time between the reception of the PDSCH that carries the MAC CE and time the corresponding TCI activation/deactivation. The set of activated TCIs may be denoted U. In various examples, U may refer to UL-related activated TCIs. For example, U may include activated joint DL/UL TCI or activated separate DL/UL TCI, e.g., a TCI codepoint that corresponds to both a DL TCI and an UL TCI which may correspond to the same (for joint DL/UL TCI) or different (for separate DL/UL TCI) spatial source RS (e.g., beam). U may also include separate UL TCI (e.g., UL-only TCI), e.g., a TCI codepoints that doesn't correspond to a DL TCI, which may mean that the applied DL TCI is not updated if the separate UL TCI is indicated, e.g., in a DCI. In some examples, duplicates are not included in U, e.g., if the same DL RS is a source RS in multiple activated TCIs, it is only included once in U. In other examples, duplicates are kept in U. In various examples, U may refer to both DL-related and UL-related activated TCIs, e.g., all activated TCIs. For example, U may include activated joint DL/UL TCI, separate DL/UL TCI, DL-only TCI, and UL-only TCI.
(Step 5) Upon the activation/deactivation of a new set of TCIs, the UE performs other updates related to SRS. The details of how this update is performed may be based on the RRC configuration. Various examples of this step will be disclosed herein.
(Step 6) The UE transmits SRS, based on the RRC configuration and the updates in the previous step. Other MAC CEs, e.g., activation of SP SRS, and DCIs, e.g., AP SRS triggering, may also affect the SRS transmission. Various examples will be disclosed further below.
(Step 7) Procedure ends.

Step 2 may be preceded by UE capability signaling, e.g., UE transmission of UE capability information to the network, conveying that the UE supports various functionalities described herein, such as update of SRS based on TCI activation.

From the base station (BS) perspective, the steps above may include the following:
(Step 1) The procedure starts.
(Step 2) The BS transmits an RRC configuration or reconfiguration to a UE.
(Step 3) The BS transmits a MAC CE for TCI activation to the UE.
(Step 4) Following MAC CE reception, the corresponding TCI(s) are activated/deactivated for the UE.
(Step 5) Upon the activation/deactivation of a new set of TCIs for the UE, the BS may perform other updates related to RS transmission and/or interpretation of reporting, e.g., corresponding to the updates that the UE performs.
(Step 6) The BS receives and measures SRSs based on the updates in the previous step. The gNB may indicate a new TCI (e.g., in DCI), or activate a new set of TCI states (e.g., in a MAC CE), based on these measurements.
(Step 7) Procedure ends.

The enabling of various enhancements described herein by the network, e.g., in step 2 enabling of updating SRS TCI(s) based on TCI activation, may comprise the inclusion of an RRC parameter in an RRC information element (IE), e.g., the SRS configuration (e.g., SRS-Config) IE or in a SRS resource set configuration (e.g., SRS-ResourceSet). The enabling may also involve certain settings of existing parameters as disclosed herein. In another example, the enabling may also involve the absence of one or more parameters in a configuration. For SRS resources or SRS resource sets for which enhancements described herein is not enabled, legacy procedures may be followed, e.g., the SRS(s) or SRS spatial reference(s) are not updated upon TCI activation.

SRS resource sets may be configured with different usages, such as beam management, codebook, non-codebook, or antenna switching. For simplicity, SRS resource sets for beam management (BM) will be used in the description herein. However, the solutions disclosed may be applied to SRS resource sets with other usages.

In some cases, there may be multiple sets of activated TCIs in a BWP or a serving cell. For example, if there are multiple CORESET pools (or TRPs) configured in BWP or a serving cell, there may be a set of activated TCIs per CORESET pool (or TRPs). For example, with two pools (or TRPs), there may be two sets of activated TCIs, denoted U₁ and U₂. Various example solutions herein may be applied separately to one of the sets or both of the sets, e.g., U may be U₁ and/or U₂. The example solutions may also be to the union of the set. In some cases, an SRS resource set is associated with a CORESET pool (e.g., through the CORESET pool index). The association may be explicitly configured, e.g., by including a CORESET pool index or a related parameter in an SRS resource set configuration, or implicitly configured, e.g., through power control related parameters. In some cases, the association between an SRS resource set and a CORESET pool may be explicitly or implicitly indicated through a DCI, e.g., a DCI that triggers an aperiodic SRS resource set or a DCI that activates a semi-persistent SRS resource set. In one example, the SRS resource set may be associated with the CORESET pool to which the CORESET on which the DCI was received belongs. In another example, the DCI may include a parameter that explicitly or implicitly indicates a CORESET pool, e.g., a single bit. In another example, e.g., with multi-TRP PUSCH scheduling, the DCI may indicate one or both out of two SRS resource sets for codebook or non-codebook based PUSCH. These SRS resource sets may be associated with different TRPs or different CORESET pool indices. Based on the indicated SRS resource set (e.g., for codebook or non-codebook) and the associated CORESET pool(s) (or TRP(s)), an SRS resource set (e.g., for beam management) triggered by the same DCI may use as U the set of the associated CORESET pool (or TRP), e.g., U₁ or U₂. Similarly, an aperiodic SRS trigger may be included in a DCI that schedules PDCCH. In this case, the DCI may indicate a TCI codepoint that corresponds to a certain TRP or CORESET pool. Alternatively, the DCI may indicate a PUCCH resource that is associated with a certain CORESET pool or TRP, e.g., via its configured/activated spatial relation or TCI state, or via an explicit CORESET pool index, TRP index or TRP-related index. Then, the UE may use as U the set of activated TCIs corresponding to the CORESET pool (or TRP) indicated by the DCI, e.g., U₁ or U₂.

For periodic SRS resources (e.g., for BM), a spatial source RS may be RRC configured per SRS resource (e.g., in a TCI state or a spatial relation).

Aperiodic (AP) SRS (e.g., for BM) may be triggered by a DCI indicating one out of typically multiple AP trigger states. A trigger state may be associated with one or multiple aperiodic SRS resource sets.

In various examples, all or a subset of the SRS resources in an SRS resource set can be configured to use TCI(s) in U as spatial reference(s). Examples herein may be applicable to periodic, semi-persistent or aperiodic SRS resources and SRS resource sets.

For example, a parameter may be added to the SRS resource set configuration (e.g., SRS-ResourceSet IE) that, if configured, indicates that SRS resources in the set should use TCI(s) in U as spatial reference(s).

If the number of TCIs in U is equal to the number of SRS resources in the SRS resource set, each TCI in U may be consecutively mapped to the SRS resources. For example, the TCI corresponding to the lowest codepoint (among the TCI states in U) may be mapped to the first SRS resource, e.g., the first entry in the list that defines the set of SRS resources that are included in the resource set, etc.

If the number of TCIs in U is greater than the number of SRS resources, a subset of the TCIs in U may be mapped to the SRS resources. The same mapping order as for equal numbers may be followed, resulting in that one or more TCI in U corresponding to the highest TCI codepoints are not mapped to SRS resources.

If the number of TCIs in U is smaller than the number of SRS resources, there are several options. In some cases, all configured SRS resources are transmitted. In other cases, not all configured SRS resources are transmitted, e.g., only as many SRS resources as there are TCIs in U are transmitted.

For example, TCIs in U are mapped (e.g., once) to the first SRS resources. The remaining SRS resources may use configured spatial references or the spatial reference is up to the UE implementation.

In another example, the TCIs in U are mapped to all SRS resources in a round-robin fashion, e.g., after the last TCI in U (e.g., corresponding to the highest codepoint) has been mapped to an SRS resource, the first TCI in U is mapped to the next SRS resource etc.

In yet another example, TCIs in U are mapped (once) to the first SRS resources. The remaining SRS resources are not transmitted. Note that the next time the SRS resource set is about to be transmitted, e.g., the next time it is triggered in the case of AP SRS, the number of TCIs in U may have been changed, perhaps resulting in transmission of SRS resources that weren't transmitted in the previous occasion.

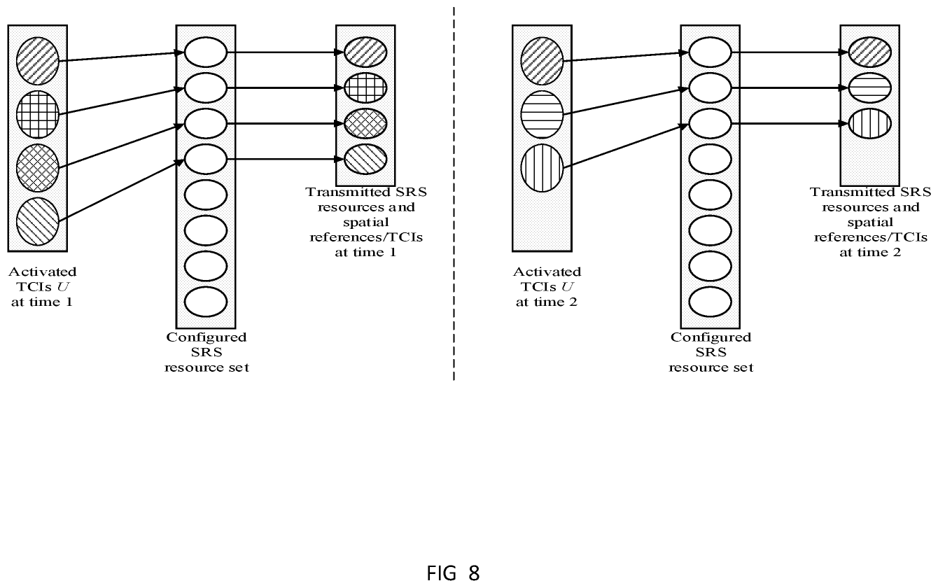

An exemplary illustration is shown in FIG. 8. The process to determine the transmitted SRS resources and the corresponding spatial references from the activated TCIs U and an SRS resource set is shown at two different times, time 1 and time 2. An SRS resource set with 8 configured SRS resources is considered. At time 1, U comprises 4 TCIs, so 4 SRS resources may be transmitted (e.g., triggered), with each of the 4 TCIs in U being used as spatial reference for a transmitted SRS resource. The different patterns signify different TCIs. At time 2, the set of TCIs U is different. Firstly, there are only 3 activated TCIs. Secondly, the second and third TCIs have been changed, as illustrated by the different patterns. The first TCI is unchanged between time 1 and time 2. Consequently, 3 SRS resources are actually transmitted (e.g., triggered), with the corresponding TCIs in U being used.

Another approach is to configure per SRS resource whether a TCI in U should be used.

For example, a certain TCI state ID (or spatial relation ID) configured for an SRS resource in an SRS resource set indicates that a TCI in U should be used. In another example, different TCI state IDs may correspond to different TCIs in U. A certain value range of TCI state ID may be used for this purpose (e.g., 0-7), or any TCI state IDs that have not been used for a configured TCI state. The lowest TCI state ID (of those used to indicate that a TCI in U is to be used for the SRS resource) may indicate that the TCI in U corresponding to the lowest codepoint should be used, etc.

In another example, a separate list of indications of the same length as the number of SRS resources may be configured, where an indication may indicate that a TCI(s) in U can be used for the corresponding SRS resource.

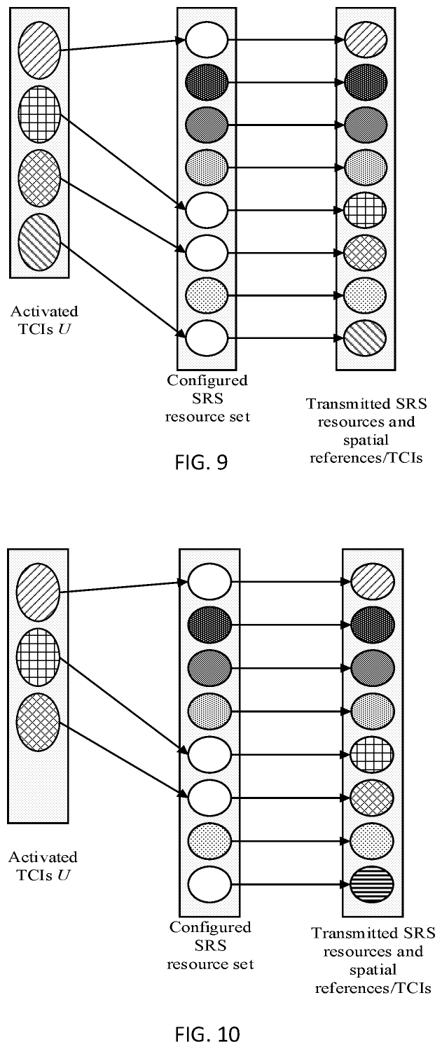

An exemplary illustration is shown in FIG. 9. Some SRS resources in the SRS resource set are configured to use a TCI in U (circles without pattern). Other SRS resources may be configured to use a configured TCI state (circles with pattern). The result may be that the UE uses the activated TCIs in U for some SRS resources, while the UE uses configured TCI states (or spatial references) for other SRS resources.

If there are more TCIs in U than triggered SRS resources (e.g., in the set) that are to use the TCIs in U, only a subset of the TCIs in U may be used for the SRS resources, e.g., the TCIs in U that correspond to the lowest codepoints.

If there are fewer TCIs in U than SRS resources that are to use the TCIs in U, some of the SRS resources may use a configured TCI state (or spatial relation) instead, e.g., the last entries in the list of SRS resources in an SRS resource set. This is illustrated in FIG. 10, where the last SRS resource is configured to use a TCI in U. However, due to too few TCIs in U, the last SRS resource uses a configured TCI state instead.

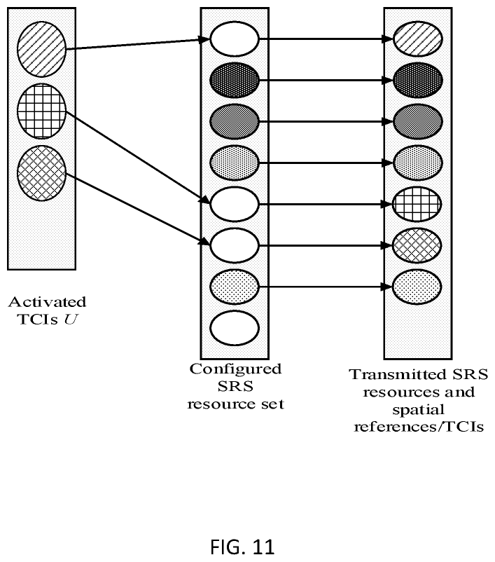

In another example, an SRS resource (e.g., in an SRS resource set) might not be triggered if it has been configured to use a TCI in U, but there are too few TCIs in U. Furthermore, in this case, a TCI state might not have been configured for the SRS resource. An exemplary illustration is shown in FIG. 11, where the last SRS resource is configured to use a TCI in U. However, due to too few TCIs in U, a TCI state in U is not assigned to the last SRS resource and it is not transmitted.

In some cases, which TCI(s) to use as a spatial reference for SRS resource(s) or an SRS resource set may be based on the current TCI and the secondary TCI(s) (e.g., see above for definition). In some cases, the current TCI and the secondary TCI(s) are used for SRS resource(s). In some cases, the current TCI is assigned to an SRS resource first, and secondary TCI(s) are assigned second. In some cases, only secondary TCI(s) are assigned to SRS resource(s). This may be useful if the current TCI is assigned to an SRS resource elsewhere, e.g., for another SRS resource set.

### Example Communications System

The 3rd Generation Partnership Project (3GPP) develops technical standards for cellular telecommunications network technologies, including radio access, the core transport network, and service capabilities—including work on codecs, security, and quality of service. Recent radio access technology (RAT) standards include WCDMA (commonly referred as 3G), LTE (commonly referred as 4G), LTE-Advanced standards, and New Radio (NR), which is also referred to as “5G”. 3GPP NR standards development is expected to continue and include the definition of next generation radio access technology (new RAT), which is expected to include the provision of new flexible radio access below 7 GHz, and the provision of new ultra-mobile broadband radio access above 7 GHz. The flexible radio access is expected to consist of a new, non-backwards compatible radio access in new spectrum below 7 GHz, and it is expected to include different operating modes that may be multiplexed together in the same spectrum to address a broad set of 3GPP NR use cases with diverging requirements. The ultra-mobile broadband is expected to include cmWave and mmWave spectrum that may provide the opportunity for ultra-mobile broadband access for, e.g., indoor applications and hotspots. In particular, the ultra-mobile broadband is expected to share a common design framework with the flexible radio access below 7 GHz, with cmWave and mmWave specific design optimizations.

3GPP has identified a variety of use cases that NR is expected to support, resulting in a wide variety of user experience requirements for data rate, latency, and mobility. The use cases include the following general categories: enhanced mobile broadband (eMBB) ultra-reliable low-latency Communication (URLLC), massive machine type communications (mMTC), network operation (e.g., network slicing, routing, migration and interworking, energy savings), and enhanced vehicle-to-everything (eV2X) communications, which may include any of Vehicle-to-Vehicle Communication (V2V), Vehicle-to-Infrastructure Communication (V2I), Vehicle-to-Network Communication (V2N), Vehicle-to-Pedestrian Communication (V2P), and vehicle communications with other entities. Specific service and applications in these categories include, e.g., monitoring and sensor networks, device remote controlling, bi-directional remote controlling, personal cloud computing, video streaming, wireless cloud-based office, first responder connectivity, automotive ecall, disaster alerts, real-time gaming, multi-person video calls, autonomous driving, augmented reality, tactile internet, virtual reality, home automation, robotics, and aerial drones to name a few. All of these use cases and others are contemplated herein.

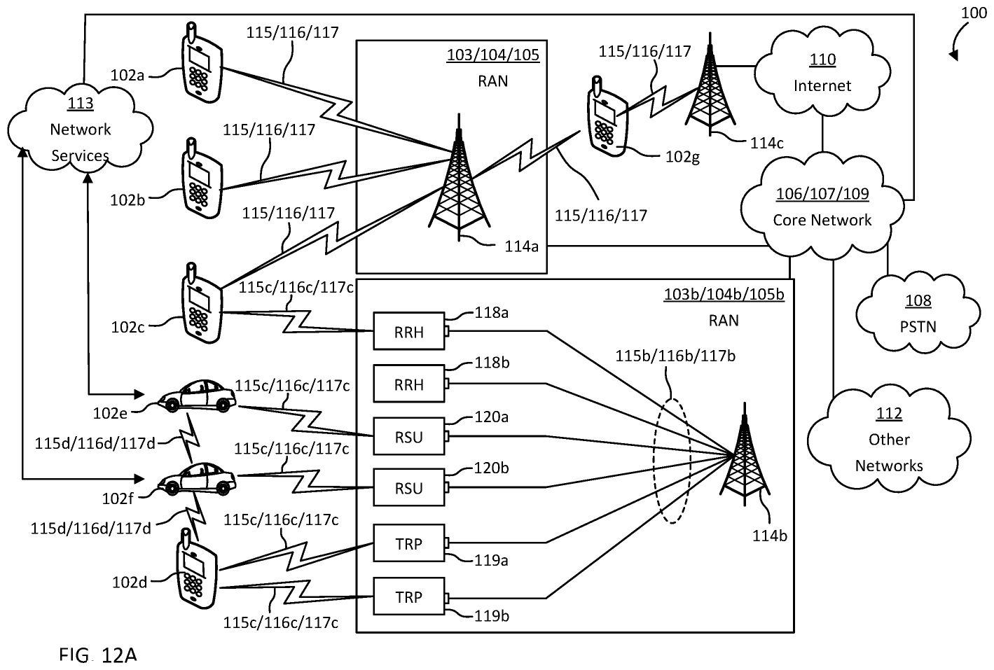

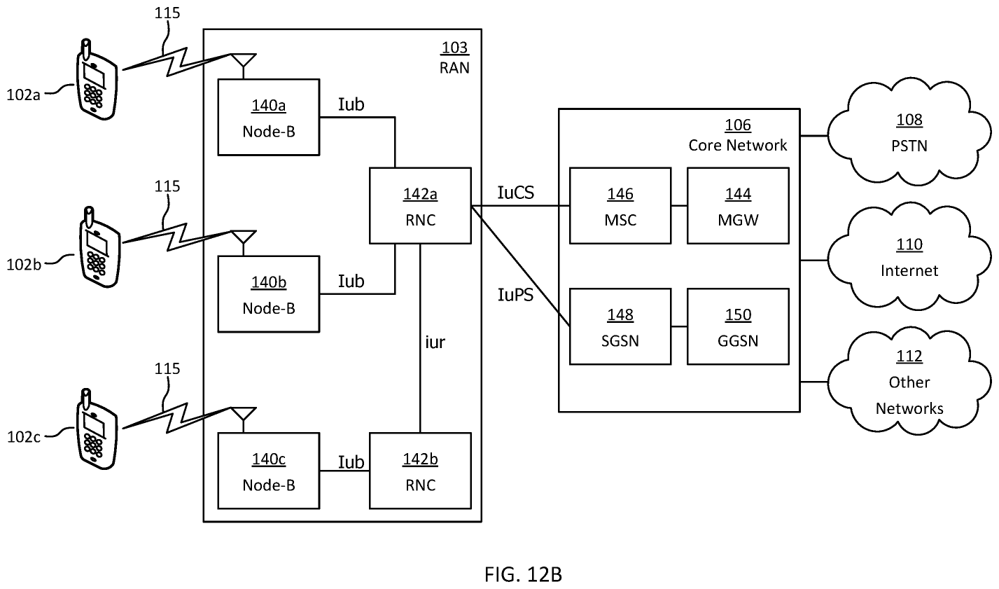

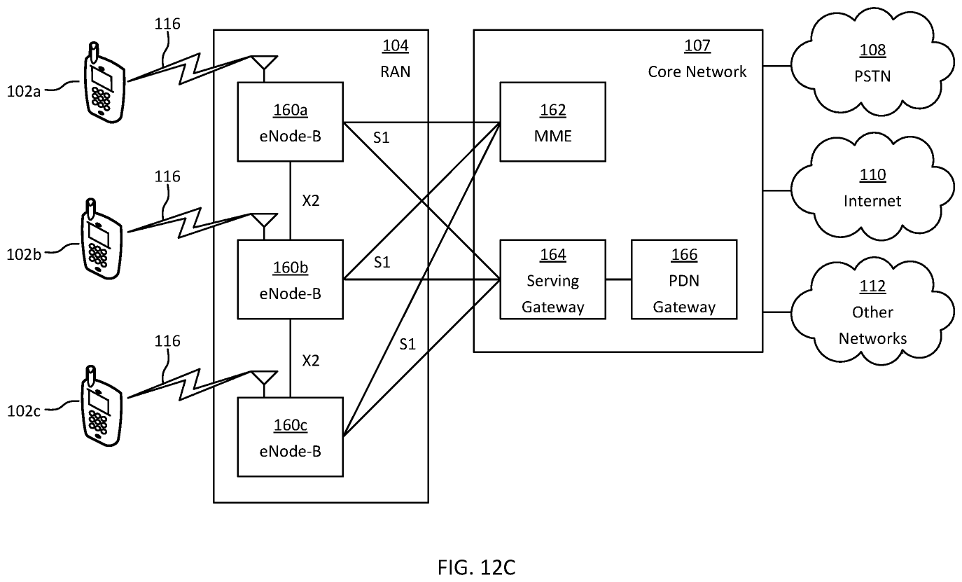

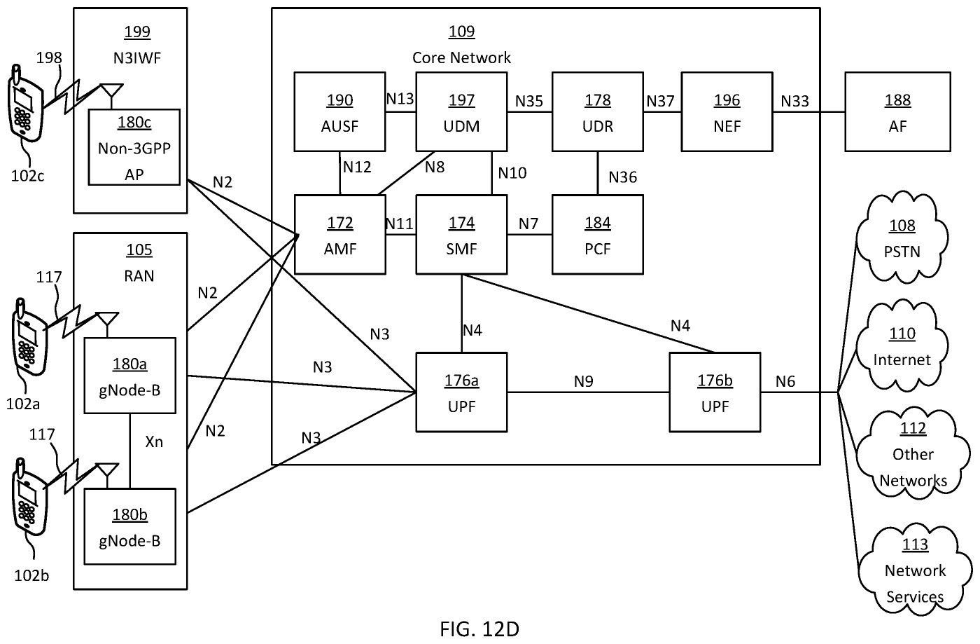

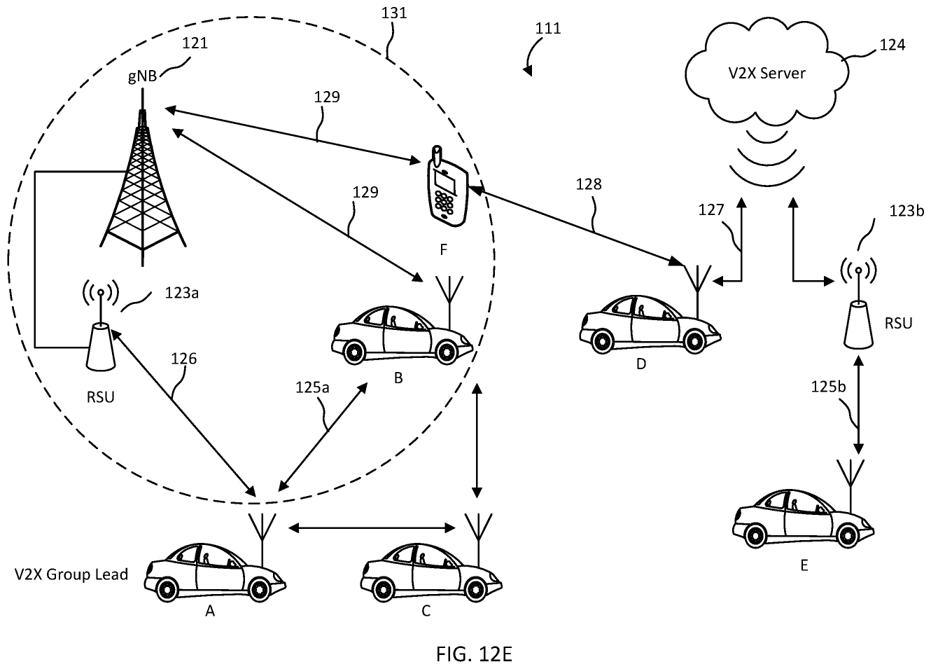

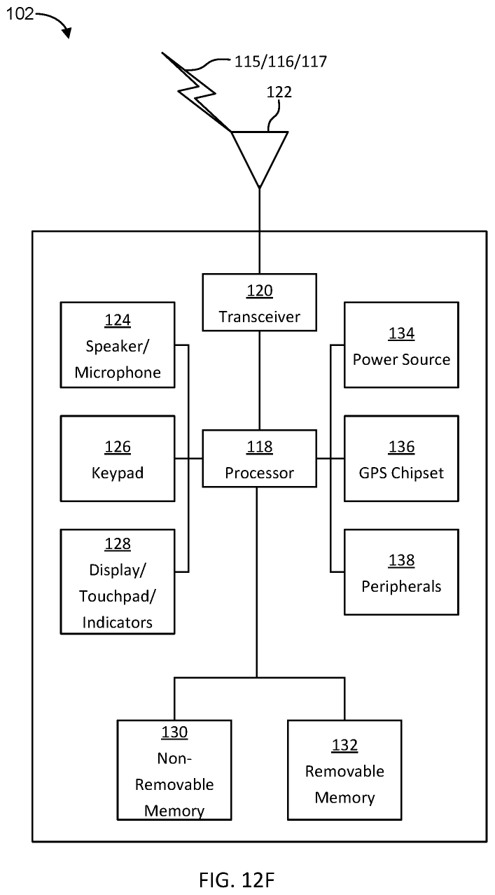

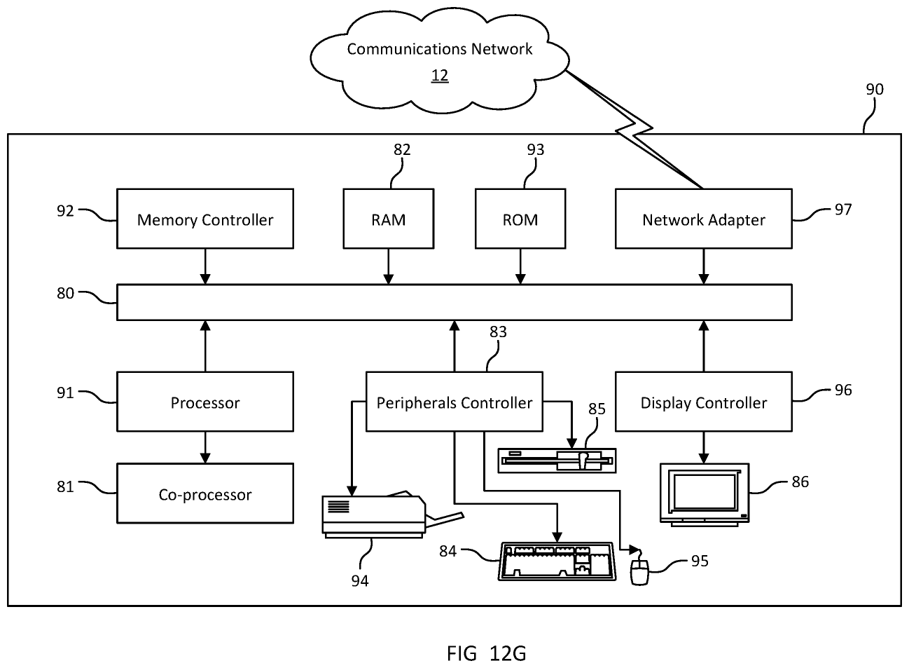

FIG. 12A illustrates an example communications system 100 in which the systems, methods, and apparatuses described and claimed herein may be used. The communications system 100 may include wireless transmit/receive units (WTRUs) 102a, 102b, 102c, 102d, 102e, 102f, and/or 102g, which generally or collectively may be referred to as WTRU 102 or WTRUs 102. The communications system 100 may include, a radio access network (RAN) 103/104/105/103b/104b/105b, a core network 106/107/109, a public switched telephone network (PSTN) 108, the Internet 110, other networks 112, and Network Services 113. 113. Network Services 113 may include, for example, a V2X server, V2X functions, a ProSe server, ProSe functions, IoT services, video streaming, and/or edge computing, etc.

It may be appreciated that the concepts disclosed herein may be used with any number of WTRUs, base stations, networks, and/or network elements. Each of the WTRUs 102 may be any type of apparatus or device configured to operate and/or communicate in a wireless environment. In the example of FIG. 12A, each of the WTRUs 102 is depicted in FIGS. 8A-8E as a hand-held wireless communications apparatus. It is understood that with the wide variety of use cases contemplated for wireless communications, each WTRU may comprise or be included in any type of apparatus or device configured to transmit and/or receive wireless signals, including, by way of example only, user equipment (UE), a mobile station, a fixed or mobile subscriber unit, a pager, a cellular telephone, a personal digital assistant (PDA), a smartphone, a laptop, a tablet, a netbook, a notebook computer, a personal computer, a wireless sensor, consumer electronics, a wearable device such as a smart watch or smart clothing, a medical or eHealth device, a robot, industrial equipment, a drone, a vehicle such as a car, bus or truck, a train, or an airplane, and the like.

The communications system 100 may also include a base station 114a and a base station 114b. In the example of FIG. 12A, each base stations 114a and 114b is depicted as a single element. In practice, the base stations 114a and 114b may include any number of interconnected base stations and/or network elements. Base stations 114a may be any type of device configured to wirelessly interface with at least one of the WTRUs 102a, 102b, and 102c to facilitate access to one or more communication networks, such as the core network 106/107/109, the Internet 110, Network Services 113, and/or the other networks 112. Similarly, base station 114b may be any type of device configured to wiredly and/or wirelessly interface with at least one of the Remote Radio Heads (RRHs) 118a, 118b, Transmission and Reception Points (TRPs) 1112A, 1112B, and/or Roadside Units (RSUs) 120a and 120b to facilitate access to one or more communication networks, such as the core network 106/107/109, the Internet 110, other networks 112, and/or Network Services 113. RRHs 118a, 118b may be any type of device configured to wirelessly interface with at least one of the WTRUs 102, e.g., WTRU 102c, to facilitate access to one or more communication networks, such as the core network 106/107/109, the Internet 110, Network Services 113, and/or other networks 112.

TRPs 1112A, 1112B may be any type of device configured to wirelessly interface with at least one of the WTRU 102d, to facilitate access to one or more communication networks, such as the core network 106/107/109, the Internet 110, Network Services 113, and/or other networks 112. RSUs 120a and 120b may be any type of device configured to wirelessly interface with at least one of the WTRU 102e or 102f, to facilitate access to one or more communication networks, such as the core network 106/107/109, the Internet 110, other networks 112, and/or Network Services 113. By way of example, the base stations 114a, 114b may be a Base Transceiver Station (BTS), a Node-B, an eNode B, a Home Node B, a Home eNode B, a Next Generation Node-B (gNode B), a satellite, a site controller, an access point (AP), a wireless router, and the like.

The base station 114a may be part of the RAN 103/104/105, which may also include other base stations and/or network elements (not shown), such as a Base Station Controller (BSC), a Radio Network Controller (RNC), relay nodes, etc. Similarly, the base station 114b may be part of the RAN 103b/104b/105b, which may also include other base stations and/or network elements (not shown), such as a BSC, a RNC, relay nodes, etc. The base station 114a may be configured to transmit and/or receive wireless signals within a particular geographic region, which may be referred to as a cell (not shown). Similarly, the base station 114b may be configured to transmit and/or receive wired and/or wireless signals within a particular geographic region, which may be referred to as a cell (not shown). The cell may further be divided into cell sectors. For example, the cell associated with the base station 114a may be divided into three sectors. Thus, for example, the base station 114a may include three transceivers, e.g., one for each sector of the cell. The base station 114a may employ Multiple-Input Multiple Output (MIMO) technology and, therefore, may utilize multiple transceivers for each sector of the cell, for instance.

The base station 114a may communicate with one or more of the WTRUs 102a, 102b, 102c, and 102g over an air interface 115/116/117, which may be any suitable wireless communication link (e.g., Radio Frequency (RF), microwave, infrared (IR), ultraviolet (UV), visible light, cmWave, mmWave, etc.). The air interface 115/116/117 may be established using any suitable Radio Access Technology (RAT).

The base station 114b may communicate with one or more of the RRHs 118a and 118b, TRPs 1112A and 1112B, and/or RSUs 120a and 120b, over a wired or air interface 115b/116b/117b, which may be any suitable wired (e.g., cable, optical fiber, etc.) or wireless communication link (e.g., RF, microwave, IR, UV, visible light, cmWave, mmWave, etc.). The air interface 115b/116b/117b may be established using any suitable RAT.

The RRHs 118a, 118b, TRPs 1112A, 1112B and/or RSUs 120a, 120b, may communicate with one or more of the WTRUs 102c, 102d, 102e, 102f over an air interface 115c/116c/117c, which may be any suitable wireless communication link (e.g., RF, microwave, IR, ultraviolet UV, visible light, cmWave, mmWave, etc.) The air interface 115c/116c/117c may be established using any suitable RAT.

The WTRUs 102 may communicate with one another over a direct air interface 115d/116d/117d, such as Sidelink communication which may be any suitable wireless communication link (e.g., RF, microwave, IR, ultraviolet UV, visible light, cmWave, mmWave, etc.) The air interface 115d/116d/117d may be established using any suitable RAT.

The communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c, or RRHs 118a, 118b, TRPs 1112A, 1112B and/or RSUs 120a and 120b in the RAN 103b/104b/105b and the WTRUs 102c, 102d, 102e, and 102f, may implement a radio technology such as Universal Mobile Telecommunications System (UMTS) Terrestrial Radio Access (UTRA), which may establish the air interface 115/116/117 and/or 115c/116c/117c respectively using Wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

The base station 114a in the RAN 103/104/105 and the WTRUs 102a, 102b, 102c, and 102g, or RRHs 118a and 118b, TRPs 1112A and 1112B, and/or RSUs 120a and 120b in the RAN 103b/104b/105b and the WTRUs 102c, 102d, may implement a radio technology such as Evolved UMTS Terrestrial Radio Access (E-UTRA), which may establish the air interface 115/116/117 or 115c/116c/117c respectively using Long Term Evolution (LTE) and/or LTE-Advanced (LTE-A), for example. The air interface 115/116/117 or 115c/116c/117c may implement 3GPP NR technology. The LTE and LTE-A technology may include LTE D2D and/or V2X technologies and interfaces (such as Sidelink communications, etc.) Similarly, the 3GPP NR technology may include NR V2X technologies and interfaces (such as Sidelink communications, etc.)

The base station 114a in the RAN 103/104/105 and the WTRUs 102a, 102b, 102c, and 102g or RRHs 118a and 118b, TRPs 1112A and 1112B, and/or RSUs 120a and 120b in the RAN 103b/104b/105b and the WTRUs 102c, 102d, 102e, and 102f may implement radio technologies such as IEEE 802.16 (e.g., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114c in FIG. 12A may be a wireless router, Home Node B, Home eNode B, or access point, for example, and may utilize any suitable RAT for facilitating wireless connectivity in a localized area, such as a place of business, a home, a vehicle, a train, an aerial, a satellite, a manufactory, a campus, and the like. The base station 114c and the WTRUs 102, e.g., WTRU 102e, may implement a radio technology such as IEEE 802.11 to establish a Wireless Local Area Network (WLAN). Similarly, the base station 114c and the WTRUs 102, e.g., WTRU 102d, may implement a radio technology such as IEEE 802.15 to establish a wireless personal area network (WPAN). The base station 114c and the WTRUs 102, e.g., WRTU 102e, may utilize a cellular-based RAT (e.g., WCDMA, CDMA2000, GSM, LTE, LTE-A, NR, etc.) to establish a picocell or femtocell. As shown in FIG. 12A, the base station 114c may have a direct connection to the Internet 110. Thus, the base station 114c may not be required to access the Internet 110 via the core network 106/107/109.

The RAN 103/104/105 and/or RAN 103b/104b/105b may be in communication with the core network 106/107/109, which may be any type of network configured to provide voice, data, messaging, authorization and authentication, applications, and/or Voice Over Internet Protocol (VoIP) services to one or more of the WTRUs 102. For example, the core network 106/107/109 may provide call control, billing services, mobile location-based services, pre-paid calling, Internet connectivity, packet data network connectivity, Ethernet connectivity, video distribution, etc., and/or perform high-level security functions, such as user authentication.

Although not shown in FIG. 12A, it may be appreciated that the RAN 103/104/105 and/or RAN 103b/104b/105b and/or the core network 106/107/109 may be in direct or indirect communication with other RANs that employ the same RAT as the RAN 103/104/105 and/or RAN 103b/104b/105b or a different RAT. For example, in addition to being connected to the RAN 103/104/105 and/or RAN 103b/104b/105b, which may be utilizing an E-UTRA radio technology, the core network 106/107/109 may also be in communication with another RAN (not shown) employing a GSM or NR radio technology.

The core network 106/107/109 may also serve as a gateway for the WTRUs 102 to access the PSTN 108, the Internet 110, and/or other networks 112. The PSTN 108 may include circuit-switched telephone networks that provide Plain Old Telephone Service (POTS). The Internet 110 may include a global system of interconnected computer networks and devices that use common communication protocols, such as the Transmission Control Protocol (TCP), User Datagram Protocol (UDP), and the internet protocol (IP) in the TCP/IP internet protocol suite. The other networks 112 may include wired or wireless communications networks owned and/or operated by other service providers. For example, the networks 112 may include any type of packet data network (e.g., an IEEE 802.3 Ethernet network) or another core network connected to one or more RANs, which may employ the same RAT as the RAN 103/104/105 and/or RAN 103b/104b/105b or a different RAT.

Some or all of the WTRUs 102a, 102b, 102c, 102d, 102e, and 102f in the communications system 100 may include multi-mode capabilities, e.g., the WTRUs 102a, 102b, 102c, 102d, 102e, and 102f may include multiple transceivers for communicating with different wireless networks over different wireless links. For example, the WTRU 102g shown in FIG. 12A may be configured to communicate with the base station 114a, which may employ a cellular-based radio technology, and with the base station 114c, which may employ an IEEE 802 radio technology.

Although not shown in FIG. 12A, it may be appreciated that a User Equipment may make a wired connection to a gateway. The gateway maybe a Residential Gateway (RG). The RG may provide connectivity to a Core Network 106/107/109. It may be appreciated that many of the ideas contained herein may equally apply to UEs that are WTRUs and UEs that use a wired connection to connect to a network. For example, the ideas that apply to the wireless interfaces 115, 116, 117 and 115c/116c/117c may equally apply to a wired connection.

FIG. 12B is a system diagram of an example RAN 103 and core network 106. As noted above, the RAN 103 may employ a UTRA radio technology to communicate with the WTRUs 102a, 102b, and 102c over the air interface 115. The RAN 103 may also be in communication with the core network 106. As shown in FIG. 12B, the RAN 103 may include Node-Bs 140a, 140b, and 140c, which may each include one or more transceivers for communicating with the WTRUs 102a, 102b, and 102c over the air interface 115. The Node-Bs 140a, 140b, and 140c may each be associated with a particular cell (not shown) within the RAN 103. The RAN 103 may also include RNCs 142a, 142b. It may be appreciated that the RAN 103 may include any number of Node-Bs and Radio Network Controllers (RNCs.)

As shown in FIG. 12B, the Node-Bs 140a, 140b may be in communication with the RNC 142a. Additionally, the Node-B 140c may be in communication with the RNC 142b. The Node-Bs 140a, 140b, and 140c may communicate with the respective RNCs 142a and 142b via an Iub interface. The RNCs 142a and 142b may be in communication with one another via an Iur interface. Each of the RNCs 142a and 142b may be configured to control the respective Node-Bs 140a, 140b, and 140c to which it is connected. In addition, each of the RNCs 142a and 142b may be configured to carry out or support other functionality, such as outer loop power control, load control, admission control, packet scheduling, handover control, macro-diversity, security functions, data encryption, and the like.

The core network 106 shown in FIG. 12B may include a media gateway (MGW) 144, a Mobile Switching Center (MSC) 146, a Serving GPRS Support Node (SGSN) 148, and/or a Gateway GPRS Support Node (GGSN) 150. While each of the foregoing elements are depicted as part of the core network 106, it may be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, and 102c with access to circuit-switched networks, such as the PSTN 108, to facilitate communications between the WTRUs 102a, 102b, and 102c, and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, and 102c with access to packet-switched networks, such as the Internet 110, to facilitate communications between and the WTRUs 102a, 102b, and 102c, and IP-enabled devices.

The core network 106 may also be connected to the other networks 112, which may include other wired or wireless networks that are owned and/or operated by other service providers.

FIG. 12C is a system diagram of an example RAN 104 and core network 107. As noted above, the RAN 104 may employ an E-UTRA radio technology to communicate with the WTRUs 102a, 102b, and 102c over the air interface 116. The RAN 104 may also be in communication with the core network 107.

The RAN 104 may include eNode-Bs 160a, 160b, and 160c, though it may be appreciated that the RAN 104 may include any number of eNode-Bs. The eNode-Bs 160a, 160b, and 160c may each include one or more transceivers for communicating with the WTRUs 102a, 102b, and 102c over the air interface 116. For example, the eNode-Bs 160a, 160b, and 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink and/or downlink, and the like. As shown in FIG. 12C, the eNode-Bs 160a, 160b, and 160c may communicate with one another over an X2 interface.

The core network 107 shown in FIG. 12C may include a Mobility Management Gateway (MME) 162, a serving gateway 164, and a Packet Data Network (PDN) gateway 166. While each of the foregoing elements are depicted as part of the core network 107, it may be appreciated that any one of these elements may be owned and/or operated by an entity other than the core network operator.

The MME 162 may be connected to each of the eNode-Bs 160a, 160b, and 160c in the RAN 104 via an Si interface and may serve as a control node. For example, the MME 162 may be responsible for authenticating users of the WTRUs 102a, 102b, and 102c, bearer activation/deactivation, selecting a particular serving gateway during an initial attach of the WTRUs 102a, 102b, and 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, and 160c in the RAN 104 via the Si interface. The serving gateway 164 may generally route and forward user data packets to/from the WTRUs 102a, 102b, and 102c. The serving gateway 164 may also perform other functions, such as anchoring user planes during inter-eNode B handovers, triggering paging when downlink data is available for the WTRUs 102a, 102b, and 102c, managing and storing contexts of the WTRUs 102a, 102b, and 102c, and the like.

The serving gateway 164 may also be connected to the PDN gateway 166, which may provide the WTRUs 102a, 102b, and 102c with access to packet-switched networks, such as the Internet 110, to facilitate communications between the WTRUs 102a, 102b, 102c, and IP-enabled devices.

The core network 107 may facilitate communications with other networks. For example, the core network 107 may provide the WTRUs 102a, 102b, and 102c with access to circuit-switched networks, such as the PSTN 108, to facilitate communications between the WTRUs 102a, 102b, and 102c and traditional land-line communications devices. For example, the core network 107 may include, or may communicate with, an IP gateway (e.g., an IP Multimedia Subsystem (IMS) server) that serves as an interface between the core network 107 and the PSTN 108. In addition, the core network 107 may provide the WTRUs 102a, 102b, and 102c with access to the networks 112, which may include other wired or wireless networks that are owned and/or operated by other service providers.

FIG. 12D is a system diagram of an example RAN 105 and core network 109. The RAN 105 may employ an NR radio technology to communicate with the WTRUs 102a and 102b over the air interface 117. The RAN 105 may also be in communication with the core network 109. A Non-3GPP Interworking Function (N3IWF) 199 may employ a non-3GPP radio technology to communicate with the WTRU 102c over the air interface 198. The N3IWF 199 may also be in communication with the core network 109.

The RAN 105 may include gNode-Bs 180a and 180b. It may be appreciated that the RAN 105 may include any number of gNode-Bs. The gNode-Bs 180a and 180b may each include one or more transceivers for communicating with the WTRUs 102a and 102b over the air interface 117. When integrated access and backhaul connection are used, the same air interface may be used between the WTRUs and gNode-Bs, which may be the core network 109 via one or multiple gNBs. The gNode-Bs 180a and 180b may implement MIMO, MU-MIMO, and/or digital beamforming technology. Thus, the gNode-B 180a, for example, may use multiple antennas to transmit wireless signals to, and receive wireless signals from, the WTRU 102a. It should be appreciated that the RAN 105 may employ of other types of base stations such as an eNode-B. It may also be appreciated the RAN 105 may employ more than one type of base station. For example, the RAN may employ eNode-Bs and gNode-Bs.

The N3IWF 199 may include a non-3GPP Access Point 180c. It may be appreciated that the N3IWF 199 may include any number of non-3GPP Access Points. The non-3GPP Access Point 180c may include one or more transceivers for communicating with the WTRUs 102c over the air interface 198. The non-3GPP Access Point 180c may use the 802.11 protocol to communicate with the WTRU 102c over the air interface 198.

Each of the gNode-Bs 180a and 180b may be associated with a particular cell (not shown) and may be configured to handle radio resource management decisions, handover decisions, scheduling of users in the uplink and/or downlink, and the like. As shown in FIG. 12D, the gNode-Bs 180a and 180b may communicate with one another over an Xn interface, for example.

The core network 109 shown in FIG. 12D may be a 5G core network (5GC). The core network 109 may offer numerous communication services to customers who are interconnected by the radio access network. The core network 109 comprises a number of entities that perform the functionality of the core network. As used herein, the term “core network entity” or “network function” refers to any entity that performs one or more functionalities of a core network. It is understood that such core network entities may be logical entities that are implemented in the form of computer-executable instructions (software) stored in a memory of, and executing on a processor of, an apparatus configured for wireless and/or network communications or a computer system, such as system 90 illustrated in FIG. 12G.

In the example of FIG. 12D, the 5G Core Network 109 may include an access and mobility management function (AMF) 172, a Session Management Function (SMF) 174, User Plane Functions (UPFs) 176a and 176b, a User Data Management Function (UDM) 197, an Authentication Server Function (AUSF) 190, a Network Exposure Function (NEF) 196, a Policy Control Function (PCF) 184, a Non-3GPP Interworking Function (N3IWF) 199, a User Data Repository (UDR) 178. While each of the foregoing elements are depicted as part of the 5G core network 109, it may be appreciated that any one of these elements may be owned and/or operated by an entity other than the core network operator. It may also be appreciated that a 5G core network may not consist of all of these elements, may consist of additional elements, and may consist of multiple instances of each of these elements. FIG. 12D shows that network functions directly connect to one another, however, it should be appreciated that they may communicate via routing agents such as a diameter routing agent or message buses.

In the example of FIG. 12D, connectivity between network functions is achieved via a set of interfaces, or reference points. It may be appreciated that network functions may be modeled, described, or implemented as a set of services that are invoked, or called, by other network functions or services. Invocation of a Network Function service may be achieved via a direct connection between network functions, an exchange of messaging on a message bus, calling a software function, etc.

The AMF 172 may be connected to the RAN 105 via an N2 interface and may serve as a control node. For example, the AMF 172 may be responsible for registration management, connection management, reachability management, access authentication, access authorization. The AMF may be responsible forwarding user plane tunnel configuration information to the RAN 105 via the N2 interface. The AMF 172 may receive the user plane tunnel configuration information from the SMF via an N11 interface. The AMF 172 may generally route and forward NAS packets to/from the WTRUs 102a, 102b, and 102c via an N1 interface. The N1 interface is not shown in FIG. 12D.

The SMF 174 may be connected to the AMF 172 via an N11 interface. Similarly the SMF may be connected to the PCF 184 via an N7 interface, and to the UPFs 176a and 176b via an N4 interface. The SMF 174 may serve as a control node. For example, the SMF 174 may be responsible for Session Management, IP address allocation for the WTRUs 102a, 102b, and 102c, management and configuration of traffic steering rules in the UPF 176a and UPF 176b, and generation of downlink data notifications to the AMF 172.

The UPF 176a and UPF 176b may provide the WTRUs 102a, 102b, and 102c with access to a Packet Data Network (PDN), such as the Internet 110, to facilitate communications between the WTRUs 102a, 102b, and 102c and other devices. The UPF 176a and UPF 176b may also provide the WTRUs 102a, 102b, and 102c with access to other types of packet data networks. For example, Other Networks 112 may be Ethernet Networks or any type of network that exchanges packets of data. The UPF 176a and UPF 176b may receive traffic steering rules from the SMF 174 via the N4 interface. The UPF 176a and UPF 176b may provide access to a packet data network by connecting a packet data network with an N6 interface or by connecting to each other and to other UPFs via an N9 interface. In addition to providing access to packet data networks, the UPF 176 may be responsible packet routing and forwarding, policy rule enforcement, quality of service handling for user plane traffic, downlink packet buffering.

The AMF 172 may also be connected to the N3IWF 199, for example, via an N2 interface. The N3IWF facilitates a connection between the WTRU 102c and the 5G core network 170, for example, via radio interface technologies that are not defined by 3GPP. The AMF may interact with the N3IWF 199 in the same, or similar, manner that it interacts with the RAN 105.

The PCF 184 may be connected to the SMF 174 via an N7 interface, connected to the AMF 172 via an N15 interface, and to an Application Function (AF) 188 via an N5 interface. The N15 and N5 interfaces are not shown in FIG. 12D. The PCF 184 may provide policy rules to control plane nodes such as the AMF 172 and SMF 174, allowing the control plane nodes to enforce these rules. The PCF 184, may send policies to the AMF 172 for the WTRUs 102a, 102b, and 102c so that the AMF may deliver the policies to the WTRUs 102a, 102b, and 102c via an N1 interface. Policies may then be enforced, or applied, at the WTRUs 102a, 102b, and 102c.

The UDR 178 may act as a repository for authentication credentials and subscription information. The UDR may connect to network functions, so that network function may add to, read from, and modify the data that is in the repository. For example, the UDR 178 may connect to the PCF 184 via an N36 interface. Similarly, the UDR 178 may connect to the NEF 196 via an N37 interface, and the UDR 178 may connect to the UDM 197 via an N35 interface.

The UDM 197 may serve as an interface between the UDR 178 and other network functions. The UDM 197 may authorize network functions to access of the UDR 178. For example, the UDM 197 may connect to the AMF 172 via an N8 interface, the UDM 197 may connect to the SMF 174 via an N10 interface. Similarly, the UDM 197 may connect to the AUSF 190 via an N13 interface. The UDR 178 and UDM 197 may be tightly integrated.

The AUSF 190 performs authentication related operations and connects to the UDM 178 via an N13 interface and to the AMF 172 via an N12 interface.

The NEF 196 exposes capabilities and services in the 5G core network 109 to Application Functions (AF) 188. Exposure may occur on the N33 API interface. The NEF may connect to an AF 188 via an N33 interface and it may connect to other network functions in order to expose the capabilities and services of the 5G core network 109.

Application Functions 188 may interact with network functions in the 5G Core Network 109. Interaction between the Application Functions 188 and network functions may be via a direct interface or may occur via the NEF 196. The Application Functions 188 may be considered part of the 5G Core Network 109 or may be external to the 5G Core Network 109 and deployed by enterprises that have a business relationship with the mobile network operator.

Network Slicing is a mechanism that may be used by mobile network operators to support one or more ‘virtual’ core networks behind the operator's air interface. This involves ‘slicing’ the core network into one or more virtual networks to support different RANs or different service types running across a single RAN. Network slicing enables the operator to create networks customized to provide optimized solutions for different market scenarios which demands diverse requirements, e.g., in the areas of functionality, performance and isolation.

3GPP has designed the 5G core network to support Network Slicing. Network Slicing is a good tool that network operators may use to support the diverse set of 5G use cases (e.g., massive IoT, critical communications, V2X, and enhanced mobile broadband) which demand very diverse and sometimes extreme requirements. Without the use of network slicing techniques, it is likely that the network architecture would not be flexible and scalable enough to efficiently support a wider range of use cases need when each use case has its own specific set of performance, scalability, and availability requirements. Furthermore, introduction of new network services should be made more efficient.

Referring again to FIG. 12D, in a network slicing scenario, a WTRU 102a, 102b, or 102c may connect to an AMF 172, via an N1 interface. The AMF may be logically part of one or more slices. The AMF may coordinate the connection or communication of WTRU 102a, 102b, or 102c with one or more UPF 176a and 176b, SMF 174, and other network functions. Each of the UPFs 176a and 176b, SMF 174, and other network functions may be part of the same slice or different slices. When they are part of different slices, they may be isolated from each other in the sense that they may utilize different computing resources, security credentials, etc.

The core network 109 may facilitate communications with other networks. For example, the core network 109 may include, or may communicate with, an IP gateway, such as an IP Multimedia Subsystem (IMS) server, that serves as an interface between the 5G core network 109 and a PSTN 108. For example, the core network 109 may include, or communicate with a short message service (SMS) service center that facilities communication via the short message service. For example, the 5G core network 109 may facilitate the exchange of non-IP data packets between the WTRUs 102a, 102b, and 102c and servers or applications functions 188. In addition, the core network 170 may provide the WTRUs 102a, 102b, and 102c with access to the networks 112, which may include other wired or wireless networks that are owned and/or operated by other service providers.

The core network entities described herein and illustrated in FIGS. 8A, 8C, 8D, and 8E are identified by the names given to those entities in certain existing 3GPP specifications, but it is understood that in the future those entities and functionalities may be identified by other names and certain entities or functions may be combined in future specifications published by 3GPP, including future 3GPP NR specifications. Thus, the particular network entities and functionalities described and illustrated in FIGS. 8A, 8B, 8C, 8D, and 8E are provided by way of example only, and it is understood that the subject matter disclosed and claimed herein may be embodied or implemented in any similar communication system, whether presently defined or defined in the future.

FIG. 12E illustrates an example communications system 111 in which the systems, methods, apparatuses described herein may be used. Communications system 111 may include Wireless Transmit/Receive Units (WTRUs) A, B, C, D, E, F, a base station gNB 121, a V2X server 124, and Road Side Units (RSUs) 123a and 123b. In practice, the concepts presented herein may be applied to any number of WTRUs, base station gNBs, V2X networks, and/or other network elements. One or several or all WTRUs A, B, C, D, E, and F may be out of range of the access network coverage 131. WTRUs A, B, and C form a V2X group, among which WTRU A is the group lead and WTRUs B and C are group members.

WTRUs A, B, C, D, E, and F may communicate with each other over a Uu interface 129 via the gNB 121 if they are within the access network coverage 131. In the example of FIG. 12E, WTRUs B and F are shown within access network coverage 131. WTRUs A, B, C, D, E, and F may communicate with each other directly via a Sidelink interface (e.g., PC5 or NR PC5) such as interface 125a, 125b, or 128, whether they are under the access network coverage 131 or out of the access network coverage 131. For instance, in the example of FIG. 12E, WRTU D, which is outside of the access network coverage 131, communicates with WTRU F, which is inside the coverage 131.

WTRUs A, B, C, D, E, and F may communicate with RSU 123a or 123b via a Vehicle-to-Network (V2N) 133 or Sidelink interface 125b. WTRUs A, B, C, D, E, and F may communicate to a V2X Server 124 via a Vehicle-to-Infrastructure (V2I) interface 127. WTRUs A, B, C, D, E, and F may communicate to another UE via a Vehicle-to-Person (V2P) interface 128.

FIG. 12F is a block diagram of an example apparatus or device WTRU 102 that may be configured for wireless communications and operations in accordance with the systems, methods, and apparatuses described herein, such as a WTRU 102 of FIG. 12A, 8B, 8C, 8D, or 8E. As shown in FIG. 12F, the example WTRU 102 may include a processor 118, a transceiver 120, a transmit/receive element 122, a speaker/microphone 124, a keypad 126, a display/touchpad/indicators 128, non-removable memory 130, removable memory 132, a power source 134, a global positioning system (GPS) chipset 136, and other peripherals 138. It may be appreciated that the WTRU 102 may include any sub-combination of the foregoing elements. Also, the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, a next generation node-B (gNode-B), and proxy nodes, among others, may include some or all of the elements depicted in FIG. 12F and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 12F depicts the processor 118 and the transceiver 120 as separate components, it may be appreciated that the processor 118 and the transceiver 120 may be integrated together in an electronic package or chip.

The transmit/receive element 122 of a UE may be configured to transmit signals to, or receive signals from, a base station (e.g., the base station 114a of FIG. 12A) over the air interface 115/116/117 or another UE over the air interface 115d/116d/117d. For example, the transmit/receive element 122 may be an antenna configured to transmit and/or receive RF signals. The transmit/receive element 122 may be an emitter/detector configured to transmit and/or receive IR, UV, or visible light signals, for example. The transmit/receive element 122 may be configured to transmit and receive both RF and light signals. It may be appreciated that the transmit/receive element 122 may be configured to transmit and/or receive any combination of wireless or wired signals.

In addition, although the transmit/receive element 122 is depicted in FIG. 12F as a single element, the WTRU 102 may include any number of transmit/receive elements 122. More specifically, the WTRU 102 may employ MIMO technology. Thus, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, for example NR and IEEE 802.11 or NR and E-UTRA, or to communicate with the same RAT via multiple beams to different RRHs, TRPs, RSUs, or nodes.

The processor 118 of the WTRU 102 may be coupled to, and may receive user input data from, the speaker/microphone 124, the keypad 126, and/or the display/touchpad/indicators 128 (e.g., a liquid crystal display (LCD) display unit or organic light-emitting diode (OLED) display unit. The processor 118 may also output user data to the speaker/microphone 124, the keypad 126, and/or the display/touchpad/indicators 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. The processor 118 may access information from, and store data in, memory that is not physically located on the WTRU 102, such as on a server that is hosted in the cloud or in an edge computing platform or in a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries, solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It may be appreciated that the WTRU 102 may acquire location information by way of any suitable location-determination method.

The processor 118 may further be coupled to other peripherals 138, which may include one or more software and/or hardware modules that provide additional features, functionality, and/or wired or wireless connectivity. For example, the peripherals 138 may include various sensors such as an accelerometer, biometrics (e.g., finger print) sensors, an e-compass, a satellite transceiver, a digital camera (for photographs or video), a universal serial bus (USB) port or other interconnect interfaces, a vibration device, a television transceiver, a hands free headset, a Bluetooth® module, a frequency modulated (FM) radio unit, a digital music player, a media player, a video game player module, an Internet browser, and the like.

The WTRU 102 may be included in other apparatuses or devices, such as a sensor, consumer electronics, a wearable device such as a smart watch or smart clothing, a medical or eHealth device, a robot, industrial equipment, a drone, a vehicle such as a car, truck, train, or an airplane. The WTRU 102 may connect to other components, modules, or systems of such apparatuses or devices via one or more interconnect interfaces, such as an interconnect interface that may comprise one of the peripherals 138.

FIG. 12G is a block diagram of an exemplary computing system 90 in which one or more apparatuses of the communications networks illustrated in FIGS. 8A, 8C, 8D and 8E may be embodied, such as certain nodes or functional entities in the RAN 103/104/105, Core Network 106/107/109, PSTN 108, Internet 110, Other Networks 112, or Network Services 113. Computing system 90 may comprise a computer or server and may be controlled primarily by computer readable instructions, which may be in the form of software, wherever, or by whatever means such software is stored or accessed. Such computer readable instructions may be executed within a processor 91, to cause computing system 90 to do work. The processor 91 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 91 may perform signal coding, data processing, power control, input/output processing, and/or any other functionality that enables the computing system 90 to operate in a communications network. Coprocessor 81 is an optional processor, distinct from main processor 91, that may perform additional functions or assist processor 91. Processor 91 and/or coprocessor 81 may receive, generate, and process data related to the methods and apparatuses disclosed herein.

In operation, processor 91 fetches, decodes, and executes instructions, and transfers information to and from other resources via the computing system's main data-transfer path, system bus 80. Such a system bus connects the components in computing system 90 and defines the medium for data exchange. System bus 80 typically includes data lines for sending data, address lines for sending addresses, and control lines for sending interrupts and for operating the system bus. An example of such a system bus 80 is the PCI (Peripheral Component Interconnect) bus.

Memories coupled to system bus 80 include random access memory (RAM) 82 and read only memory (ROM) 93. Such memories include circuitry that allows information to be stored and retrieved. ROMs 93 generally contain stored data that may not easily be modified. Data stored in RAM 82 may be read or changed by processor 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it may not access memory within another process's virtual address space unless memory sharing between the processes has been set up.

In addition, computing system 90 may contain peripherals controller 83 responsible for communicating instructions from processor 91 to peripherals, such as printer 94, keyboard 84, mouse 95, and disk drive 85.

Display 86, which is controlled by display controller 96, is used to display visual output generated by computing system 90. Such visual output may include text, graphics, animated graphics, and video. The visual output may be provided in the form of a graphical user interface (GUI). Display 86 may be implemented with a CRT-based video display, an LCD-based flat-panel display, gas plasma-based flat-panel display, or a touch-panel. Display controller 96 includes electronic components required to generate a video signal that is sent to display 86.

Further, computing system 90 may contain communication circuitry, such as for example a wireless or wired network adapter 97, that may be used to connect computing system 90 to an external communications network or devices, such as the RAN 103/104/105, Core Network 106/107/109, PSTN 108, Internet 110, WTRUs 102, or Other Networks 112 of FIGS. 8A, 8B, 8C, 8D, and 8E, to enable the computing system 90 to communicate with other nodes or functional entities of those networks. The communication circuitry, alone or in combination with the processor 91, may be used to perform the transmitting and receiving steps of certain apparatuses, nodes, or functional entities described herein.

It is understood that any or all of the apparatuses, systems, methods and processes described herein may be embodied in the form of computer executable instructions (e.g., program code) stored on a computer-readable storage medium which instructions, when executed by a processor, such as processors 118 or 91, cause the processor to perform and/or implement the systems, methods and processes described herein. Specifically, any of the steps, operations, or functions described herein may be implemented in the form of such computer executable instructions, executing on the processor of an apparatus or computing system configured for wireless and/or wired network communications. Computer readable storage media includes volatile and nonvolatile, removable and non-removable media implemented in any non-transitory (e.g., tangible or physical) method or technology for storage of information, but such computer readable storage media do not include signals. Computer readable storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible or physical medium which may be used to store the desired information and which may be accessed by a computing system.

What is claimed is:

1.-20. (canceled)

21. A method implemented by a wireless transmit/receive unit (WTRU), the method comprising:
receiving a radio resource control (RRC) configuration comprising a set of transmission configuration indicator (TCI) states and an indication of an association between a subset of the set of TCI states for physical downlink shared channel (PDSCH) reception and one or more configuration parameters to be applied for a channel state information (CSI) reporting upon activation of the subset of the set TCI states for PDSCH reception;
receiving a medium access control (MAC) control element (CE) indicating activation of the subset of the set of TCI states for PDSCH reception;
activating, based on the MAC CE and for PDSCH reception, the subset of the set of TCI states;
determining, based on the activation of the subset of the set of TCI states, to apply the one or more configuration parameters for CSI reporting; and
performing, based on the one or more configuration parameters for CSI reporting, CSI measurement and CSI reporting.

22. The method of claim 21, wherein the one or more configuration parameters for CSI reporting comprise a configuration for a CSI resource set to be applied for CSI reporting.

23. The method of claim 21, wherein the one or more configuration parameters for CSI reporting comprise an indication of a quasi co-location (QCL) relation with at least one reference signal for at least one CSI resource for CSI reporting.

24. The method of claim 21, wherein the RRC configuration comprises a set of links between one or more TCI states of the subset of the set of TCI states and one or more linked CSI resources, and wherein determining, based on the activation of the subset of the set of TCI states, to apply the one or more configuration parameters for CSI reporting comprises adding the one or more linked CSI resources to the one or more configuration parameters for CSI reporting.

25. The method of claim 21, wherein the subset of the set of TCI states comprises one or more source reference signals and wherein determining, based on the activation of the subset of the set of TCI states, to apply the one or more configuration parameters for CSI reporting comprises adding the one or more source reference signals to the one or more configuration parameters for CSI reporting.

26. The method of claim 21, further comprising determining a reference signal based on a TCI state identifier associated with the subset of TCI states.

27. The method of claim 21, further comprising configuring an aperiodic CSI reference signal (CSI-RS) resource to use a TCI state of the subset of the set of TCI states.

28. The method of claim 21, wherein a TCI state of the subset of the set of TCI states is mapped to a lowest codepoint of a TCI field in a downlink control information, and the TCI state is mapped to a CSI reference signal (CSI-RS) resource of the one or more configuration parameters for CSI reporting.

29. The method of claim 21, wherein determining, based on the activation of the subset of the set of TCI states, to apply the one or more configuration parameters for CSI reporting comprises using a TCI state of the subset of the set of TCI states per an association with a CSI reference signal (CSI-RS) resource of the one or more configuration parameters.

30. The method of claim 21, wherein a bandwidth part (BWP) of a serving cell comprises a plurality of activated sets of TCI states comprising the subset of TCI states, wherein each of the plurality of activated sets are mapped to a control resource set (CORESET) pool.

31. A wireless transmit/receive unit (WTRU) comprising one or more processors and memory storing instructions that, when executed by the one or more processors, cause the WTRU to:
receive a radio resource control (RRC) configuration comprising a set of transmission configuration indicator (TCI) states and an indication of an association between a subset of the set of TCI states for physical downlink shared channel (PDSCH reception) and one or more configuration parameters to be applied for a channel state information (CSI) reporting upon activation of the subset of the set TCI states for PDSCH reception;
receive a medium access control (MAC) control element (CE) indicating activation of the subset of the set of TCI states for PDSCH reception;
activate, based on the MAC CE and for PDSCH reception, the subset of the set of TCI states;
determine, based on the activation of the subset of the set of TCI states, to apply the one or more configuration parameters for CSI reporting; and
perform, based on the one or more configuration parameters for CSI reporting, channel state information (CSI) measurement and CSI reporting.

32. The WTRU of claim 31, wherein the one or more configuration parameters for CSI reporting comprise a configuration for a CSI resource set to be applied for CSI reporting.

33. The WTRU of claim 31, wherein the one or more configuration parameters for CSI reporting comprise an indication of a quasi co-location (QCL) relation with at least one reference signal for at least one CSI resource for CSI reporting.

34. The WTRU of claim 31, wherein the RRC configuration comprises a set of links between one or more TCI states of the subset of the set of TCI states and one or more linked CSI resources, and wherein determining, based on the activation of the subset of the set of TCI states, to apply the one or more configuration parameters for CSI reporting comprises adding the one or more linked CSI resources to the one or more configuration parameters for CSI reporting.

35. The WTRU of claim 31, wherein the subset of the set of TCI states comprises one or more source reference signals and wherein determining, based on the activation of the subset of the set of TCI states, to apply the one or more configuration parameters for CSI reporting comprises adding the one or more source reference signals to the one or more configuration parameters for CSI reporting.

36. The WTRU of claim 31, further configured to cause the WTRU to determine a reference signal based on a TCI state identifier associated with the subset of the set of TCI states.

37. The WTRU of claim 31, further configured to configure an aperiodic CSI reference signal (CSI-RS) resource to use a TCI state of the subset of the set of TCI states.

38. The WTRU of claim 31, wherein a TCI state of the subset of the set of TCI states is mapped to a lowest codepoint of a TCI field in a downlink control information, and the TCI state is mapped to a CSI reference signal (CSI-RS) resource of the one or more configuration parameters for CSI reporting.

39. The WTRU of claim 31, wherein determining, based on the activation of the subset of TCI states, to apply the one or more configuration parameters for CSI reporting comprises using a TCI state of the subset of the set of TCI states per an association with a channel state information reference signal (CSI-RS) resource of the one or more configuration parameters.

40. The WTRU of claim 31, wherein a bandwidth part (BWP) of a serving cell comprises a plurality of activated sets of TCI states comprising the subset of TCI states, wherein each of the plurality of activated sets are mapped to a control resource set (CORESET) pool.
